(19) United States
(12) Patent Application Publication
(10) Pub. No.: US 2025/0202528 A1
(43) Pub. Date: Jun. 19, 2025

(54) CAPACITIVE COMMUNICATION SYSTEM AND CONFIGURATION

(71) Applicant: Infineon Technologies Austria AG, Villach (AT)

(72) Inventors: Filipe ESTEVES TAVORA, Villach (AT); Thomas FERIANZ, Bodensdorf (AT); Gernot KASEBACHER, Treffen (AT)

(21) Appl. No.: 18/543,096

(22) Filed: Dec. 18, 2023

(51) Int. Cl. H04B 5/22; H04L 5/00

(52) U.S. Cl. CPC H04B 5/22; H04L 5/0048

(57) ABSTRACT

A configuration management resource as discussed herein applies configuration settings to test operation of a first capacitive coupled communication link. Via amplitude monitoring during the testing, the communication management hardware detects a respective performance of the first capacitive coupled communication link to convey communications for each of the applied configuration settings. The communication management hardware selects a first configuration setting amongst the applied configuration settings to control the operation of the first capacitive coupled communication link based on the determined performances. In one application, the best performance corresponds to maximizing an amplitude of an envelope signal associated with received communications.

### BACKGROUND

One of the main challenges in digital isolator architectures is the capability to withstand fast common mode surges across the galvanic barrier, a figure of merit known as Common Mode Transient Immunity (CMTI). Capacitive coupled digital isolators offer a better area usage while presenting a worse CMTI performance when compared to their inductively coupled counterpart. For this reason, improving the CMTI in capacitive coupled architectures is desirable.

Most commercial solutions of such architectures employ the use of blanking times to mask disturbances created by CMT events. This blanking time is added to the whole chain propagation delay of the system and is effective as long as the event duration is shorter than the blanking time. Other known solutions involve the use of passive High Pass filters to eliminate disturbances below the carrier frequency on OOK modulations but are sensitive to high-frequency interferences which could be mixed down into the signal frequency when trying to detect the signal envelope. Moreover, a passive filter attenuates the signal which makes its demodulation even harder, so to compensate for this attenuation a pre-amplifier is required as the first block in the receiver chain. Any block placed directly connected to the isolation capacitor requires extra consideration with regards to CMT events and the associated displacement current it generates, which increases the complexity of its design.

### BRIEF DESCRIPTION

In contrast to conventional techniques, this disclosure includes novel ways of supporting communications between communication nodes referenced to different ground potentials. For example, the disclosure herein includes the use of active inductors to implement an LC-oscillator on the transmitter side and a band-pass filter on the receiver side of a communication system. It is desirable to tune one or more of the LC-oscillator (carrier frequency) on the transmitter side and the band-pass filter on the receiver side of the communication system to align with each other to provide most efficient conveyance of communications. The following disclosure includes multiple methods in which to achieve this end.

More specifically, the disclosure herein includes an apparatus including configuration management hardware operative to: apply different configuration settings to test operation of a first capacitive coupled communication link; via amplitude monitoring, detect a respective performance of the first capacitive coupled communication link conveying communications for each of the applied configuration settings; and select a first configuration setting amongst the applied configuration settings to control the operation of the first capacitive coupled communication link based on the determined performances. In one example, the selected first configuration setting aligns the peak frequency of a bandpass filter at a receiver with a carrier frequency used by a transmitter to transmit data to the receiver.

In one example, the amplitude monitoring implemented by the configuration management hardware as discussed herein includes generation of respective peak-to-peak measurement associated with the communications conveyed over the first capacitive coupled communication link for each of the applied configuration settings. In such an instance, the respective peak to peak measurements are used as a basis to select the most desirable configuration setting such as the first configuration setting.

In accordance with yet further examples, the amplitude monitoring implemented by the configuration management hardware includes generation of a respective envelope detection measurement associated with the communications conveyed over the first capacitive coupled communication link for each of the applied configuration settings. In such an instance, the detection measurements associated with each of the configuration settings is used as a basis to select the most desirable configuration settings such as the first configuration setting.

Still further, the apparatus as discussed herein can be configured to include a first transmitter circuit and a first receiver circuit. The first transmitter circuit is operative to transmit the communications over the first capacitive coupled communication link to the first receiver circuit. The configuration management hardware is further operative to apply the selected first configuration setting to the first capacitive coupled communication link. Application of the selected first configuration setting results in substantially aligning a peak resonant frequency setting of the first receiver circuit with respect to a carrier frequency of the conveyed communications from the first transmitter circuit. In other words, the first transmitter circuit is operative to transmit the communications over the first capacitive coupled communication link at the carrier frequency.

Yet further examples as discussed herein include configuration management hardware operable to determine a respective performance for each respective configuration setting of the applied configuration settings based on a corresponding peak-to-peak measurement associated with the communications conveyed over the first capacitive coupled communication link. The performance associated with each configuration setting is proportional to the magnitude of the peak to peak measurement. For example, a high peak to peak measurement for a given setting corresponds to a high performance capability of the capacitive coupled communication link to convey data without errors. A low peak to peak measurement for a given configuration setting corresponds to a low performance capability of the capacitive coupled communication link to convey data without errors. As previously discussed, the communications are transmitted by the first transmitter circuit over the first capacitive coupled communication link to the first receiver circuit. The corresponding peak-to-peak measurement for each respective configuration setting may be based on a magnitude of a corresponding envelope signal associated with the communications conveyed over the first capacitive coupled communication link.

In accordance with another example, the configuration settings as discussed herein include at least the first configuration setting and a second configuration setting. The first configuration setting is a first resonant frequency setting and the second configuration setting is a second resonant frequency setting. Additionally, or alternatively, first configuration setting may be a first carrier frequency setting and the second configuration setting may be a second carrier frequency setting.

Application of the first configuration setting results in a first time delay of conveying the communications over the first capacitive coupled communication link; application of the second configuration setting results in a second time delay of conveying the communications over the first capacitive coupled communication link. The configuration management resource can be configured to select the first configuration setting in response to detecting that the first time delay is less than the second time delay or simply select the configuration setting producing the highest peak to peak measurement, which corresponds to the configuration setting providing the shortest time delay.

The testing of the capacitive coupled communication link and corresponding transmitter and receiver can occur at any time. In one example, the configuration management hardware is operative to the test operation of the first capacitive coupled communication link during uninterrupted transmission of data over the first capacitive coupled communication link from a transmitter circuit to a receiver circuit. In other words, the transmitter can be configured to transmit non-test data over the capacitive coupled communication link to a receiver. In such an instance, the configuration management hardware performs testing and calibrating of the capacitive coupled communication link without any interruptions.

In accordance with still further examples, the communications conveyed over the first capacitive coupled communication link is a modulated signal including data transmitted by the transmitter. The transmitter transmitting the modulated signal over the capacitive coupled communication link may be referenced with respect to a first ground reference voltage or potential whereas the receiver receiving the modulated signal over the capacitive coupled communication link may be referenced with respect to a second ground reference voltage or potential.

Additional examples of the configuration management hardware as described herein are operative to: apply configuration settings to test a first capacitive coupled communication link; monitor performance of the first capacitive coupled communication link conveying first communications for each of the applied configuration settings with respect to second communications conveyed over a second capacitive coupled communication link; and select a first configuration setting amongst the configuration settings to control operation of the first capacitive coupled communication link based on the monitored performance.

These and other more specific concepts are discussed in more detail below.

As discussed herein, techniques herein are well suited for use in the field of communications. However, it should be noted that this disclosure is not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion herein (BRIEF DESCRIPTION) purposefully does not specify every implementation and/or incrementally novel aspect of the present disclosure or claimed invention(s). Instead, this brief description only presents general implementations and corresponding points of novelty over conventional techniques. For additional details and/or possible perspectives (permutations) of the invention(s), the reader is directed to the Detailed Description section (which is a summary of possible implementation and operations) and corresponding figures of the present disclosure as further discussed below.

### BRIEF DESCRIPTION OF THE DRAWINGS

FIG. 1 is an example general diagram of a communication system and corresponding transmitter receiver pairs operating in first data flow mode as discussed herein.

FIG. 2 is an example general diagram of a communication system and corresponding transmitter receiver pairs operating in second data flow mode as discussed herein.

FIG. 3 is an example diagram illustrating a transmitter carrier frequency and receiver band pass filter gain (band-pass filter response) as discussed herein.

FIG. 4 is an example diagram illustrating components in a receiver as discussed herein.

FIG. 5 is an example diagram illustrating details of a receiver circuit as discussed herein.

FIG. 6 is an example diagram illustrating a displacement current dominant paths during a rising edge of a receiver ground with respect to a transmitter ground as discussed herein.

FIG. 7 is an example diagram illustrating displacement current dominant paths during a falling edge of a receiver ground with respect to a transmitter ground as discussed herein.

FIG. 8 is an example diagram illustrating an LC element in a bandpass filter as discussed herein.

FIG. 9A is an example diagram illustrating an active inductor as discussed herein.

FIG. 9B is an example diagram illustrating an equivalent circuit of the active inductor of FIG. 9A as discussed herein.

FIG. 10 is an example diagram illustrating a general architecture used for an active inductor implementation as discussed herein.

FIG. 11 is an example diagram illustrating a demodulator implementation as discussed herein.

FIGS. 12A, 12B, 12C, 12D, 12E, and 12F are example timing diagrams of signals as discussed herein.

FIG. 13 is an example diagram illustrating components of a transmitter as discussed herein.

FIG. 14 is an example diagram illustrating an oscillator implementation as discussed herein.

FIG. 15 is an example diagram illustrating an LC element associated with an oscillator as discussed herein.

FIG. 16 is an example diagram illustrating an oscillator as discussed herein.

FIG. 17 is an example diagram illustrating trimming of a transmitter carrier frequency as discussed herein.

FIG. 18 is an example diagram illustrating a first step of trimming of the transmitter carrier and receiver bandpass resonance frequency as discussed herein.

FIG. 19 is an example diagram illustrating trimming by shifting a bandpass filter resonance frequency as discussed herein.

FIG. 20 is an example diagram illustrating a second step of trimming as discussed herein.

FIG. 21 is an example diagram illustrating a demodulator envelope output signal associated with different trim codes (configuration settings) as discussed herein.

FIG. 22 is an example diagram illustrating control operation of tweaking the carrier frequency and/or resonant frequency associated with the capacitive communication link to provide optimal communication of data over a capacitive coupled communication link as discussed herein.

FIG. 23 is an example diagram illustrating an example of trim control and application of optimal configuration settings as discussed herein.

FIG. 24 is an example diagram illustrating a mode of calibrating a calibration channel as discussed herein.

FIG. 25 is an example diagram illustrating monitoring of signals associated with a calibration test as discussed herein.

FIG. 26 is an example diagram illustrating a mode of calibrating an active channel as discussed herein.

FIG. 27 is an example diagram illustrating monitoring of signals associated with a calibration test as discussed herein.

FIG. 28 is an example diagram illustrating calibration of channels in the opposite direction as discussed herein.

FIG. 29 is an example diagram illustrating calibration channels in the opposite direction as discussed herein.

FIG. 30 is an example timing diagram illustrating timing waveforms associated with calibration of the channels in the reverse direction as discussed herein.

FIG. 31 is an example diagram illustrating computer processor hardware and related software instructions that execute methods as described herein.

FIG. 32 is an example diagram illustrating of a method as discussed herein.

The foregoing and other objects, features, and advantages of the invention will be apparent from the following more particular description of preferred implementations herein, as illustrated in the accompanying drawings in which like reference characters refer to the same parts throughout the different views. The drawings are not necessarily to scale, with emphasis instead being placed upon illustrating the implementations, operations, principles, concepts, etc.

### DETAILED DESCRIPTION

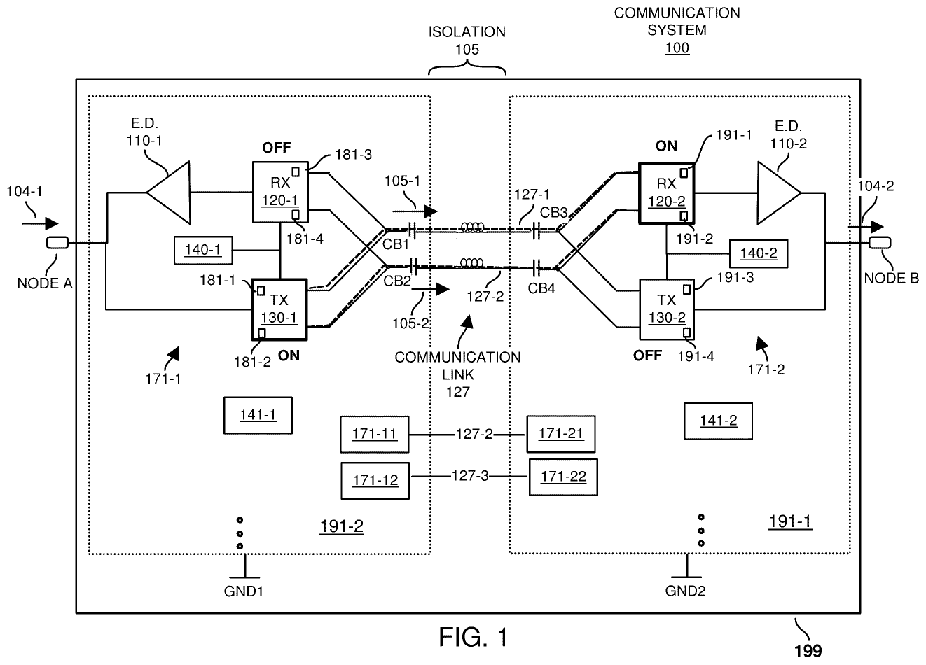

Now, more specifically, FIG. 1 is an example general diagram of a communication system and corresponding transmitter receiver pair operating in a first data flow mode (downstream) as discussed herein.

As shown, the communication system 100 includes communication circuit 171-1 (transceiver pair) and communication circuit 171-2 (transceiver pair) disposed on the substrate 199. Note that the implementation of substrate 199 is not necessary as the communication circuit 171-1 and the communication circuit 171-2 can be disparately located with respect to each other without being affixed to a common substrate 199.

Thus, the first communication circuit 171-1 and the second communication circuit 171-2 are part of a respective communication system 100. The first communication circuit 171-1 and the second communication circuit 171-2 may or may not be coupled to a common substrate 199.

Each of the communication circuit 171-1 and the communication circuit 171-2 include multiple components supporting conveyance of the data between each other. For example, the communication circuit 171-1 includes controller 140-1. The controller 140-1 controls whether the communication circuit 171-1 is set to a transmitter mode of communicating data via signals 105 to the communication circuit 171-2 or whether it is set to a receiver mode of receiving data from the communication circuit 171-2.

Similarly, the communication circuit 171-2 includes controller 140-2. The controller 140-2 controls whether the communication circuit 171-2 is set to a transmitter mode of communicating data via signals to the communication circuit 171-1 or whether it is set to a receiver mode of receiving data from the communication circuit 171-1.

In FIG. 1, the controller 140-1 controls the transmitter 130-1 and corresponding circuitry to be in an ON-state while controller 140 controls the receiver 120-1 and corresponding circuitry to be in an OFF-state. This causes the communication circuit 171-1 to be set to a transmitter mode of communicating data to the communication circuit 171-2.

Further in FIG. 1, the controller 140-2 controls the transmitter 130-2 and corresponding circuitry to be in an OFF-state while the controller 140 controls the receiver 120-2 and corresponding circuitry to be in an ON-state. This causes the communication circuit 171-2 to be set to a receiver mode of receiving data from the communication circuit 171-1.

During operation in a downstream mode (FIG. 1) from the communication circuit 171-1 to the communication circuit 171-2, the communication circuit 171-1 receives signal 104-1 at node A. Via the active inductor 181-1 and other circuitry, the transmitter 130-1 converts the received input signal 104-1 into signal 105-1 communicated over the communication path 127-1 to the receiver 120-2. Communication path 127-1 includes series disposed DC blocking capacitor CB1 and DC blocking capacitor CB3. As their name suggests, these blocking capacitors allow the AC component of the signal 105-1 transmitted by the transmitter 130-1 to pass along the communication path 127-1 to the receiver 120-2. As further illustrated, the communication path 127-1 may include some amount of parasitic inductance.

In general, the active inductor 181-1 controls a respective resonant frequency (or carrier frequency) of a modulated signal derived from the input signal 104-1; such a signal is communicated as signal 105-1 over the communication path 127-1. The receiver 120-2 includes a respective bandpass filter through which the received signal 105-1 passes to the envelope detector 110-2. The inductance of the active inductor 191-1 controls respective settings of the bandpass filter. In one implementation, it is desired that the carrier frequency of the signal 105-1 as controlled by the inductance setting of the active inductor 181-1 matches a peek bandpass carrier frequency disposed in the receiver 120-2 to provide the best gain of the received signal. To this end, in one configuration, this disclosure includes substantially matching an inductance of the active inductor 181-1 to the inductance of the active inductor 191-1 to provide most efficient communications. Additional details of this concept are further discussed below.

As shown, the communication link 127 may be implemented as a differential communication link supporting differential signals. For example, the communication link 127 may include a pair of conductive paths (communication path 127-1 and communication path 127-2) extending between the first communication circuit 171-1 and the second communication circuit 171-2. Communication path 127-2 includes series disposed DC blocking capacitor CB2 and DC blocking capacitor CB4. As their name suggests, these blocking capacitors allow the AC component of the signal 105-2 transmitted by the transmitter 130-1 to pass along the communication path 127-2 to the receiver 120-2. As further illustrated, the communication path 127-2 may include some amount of parasitic inductance.

The pair of conductive paths convey the differential signals 105-1 and 105-2 (including a respective data is captured by the input signal 104-1). For example, the communication path 127-1 conveys the signal 105-1; the communication path 127-2 conveys the signal 105-2. Thus, communication link 127 may include a first conductive path and a second conductive path extending between the first communication circuit and the second communication circuit.

As further discussed herein, the first inductance of active inductor 181-1 and the second inductance of active inductor 191-1 may be disposed in series with respect to the serial circuit path including the transmitter 130-1, active inductor 181-1, communication link 127-1, receiver 120-2, active inductor 191-1, and envelope detector 110-2 extending between the node A and node B of the communication system 100.

In the second path of communication link 127, the active inductor 181-2 controls a respective resonant frequency (or carrier frequency) of a modulation signal 105-2 derived from the input signal 104-1; such a signal is communicated as signal 105-2 over the communication path 127-2. As further discussed herein, the receiver 120-2 includes a respective bandpass filter through which the received signal 105-2 passes to the envelope detector 110-2. The inductance of the active inductor 191-2 controls respective settings (such as a band-pass resonant frequency) of the bandpass filter that receives signal 105-2. In one implementation, it is desired that the carrier frequency of the signal 105-2 as controlled by the inductance setting of the active inductor 181-2 matches a peak bandpass carrier frequency disposed in the receiver 120-2 to provide the best gain of the received signal 105-2. As previously discussed, if desired, embodiments herein include substantially matching an inductance of the active inductor 181-2 to the inductance of the active inductor 191-2. Additional details of this concept are further discussed below.

Similarly, the inductance of active inductor 181-2 and the inductance of active inductor 191-2 may be disposed in series with respect to the serial circuit path including the transmitter 130-1, active inductor 181-2, communication link 127-2, receiver 120-2, active inductor 191-2, and envelope detector 110-2 extending between the node A and node B of the communication system 100.

In accordance with further examples, the first communication circuit 171-1 and corresponding circuit components including respective active inductors may be galvanically isolated with respect to the second communication circuit 171-2 and corresponding circuit components including respective one or more active inductors. For example, the circuitry in communication circuit 171-1 may be referenced with respect to ground reference voltage/potential (GND1); the circuitry in communication circuit 171-2 may be referenced with respect to ground reference voltage/potential (GND2). Note that the different ground reference voltage potentials (i.e., GND1 versus GND2) are susceptible to experiencing large and/or frequent variations such as up to or greater than 500 volts. The configuration of the communication system 100 corresponding components supports robust communications even in conditions in which the communication circuitry experiences large differences between ground voltage potentials.

Note further that the communication link 127 can be implemented in any suitable manner. For example, the communication link 127 may be implemented via respective electrically conductive paths (such as bond wires, twisted pair wires, etc.) of any suitable length. In still further instances of the communication system 100 as described herein, a length of the communication link 127 disposed between the first communication circuit 171-1 and the second communication circuit 171-2 may be less than Y inches or any other suitable value, where Y is a value such as ¼, ½, ¾, 1, 2, 3, 4, 5, 6, 7, 8, 9, 10, etc. As previously discussed, the length of the communication link 127 may be greater than the value Y.

Note that the communication system 100 as discussed herein can be implemented in any suitable manner. For example, the communication circuit 171-1 can be implemented as a single-chip solution including one or more differential and bidirectional transceivers attached to a subsSiO2 dielectric isolation barrier between 2 metal layers, forming the capacitive channel. Placing one instance of this die (such as communication circuit 170-1) in the transmitter side of the communication system 100 and the other die (such as communication circuit 170-2) in the receiver side of the communication system 100 (rotated 180 degrees) and connecting them in series doubles the effective isolation, increasing a magnitude of a respective breakdown voltage.

Note that the single-chip including the communication circuit 171-1 can include any number of replica transceivers (such as communication circuit 171-11, 171-12, etc.; each being similar to communication circuit 171-1) on the first semiconductor chip. A second semiconductor chip can be configured to include the communication circuit 171-2 and can include any number of replica transceivers (such as communication circuit 171-21, 171-22, etc.; each being similar to communication circuit 171-2) on that same second semiconductor chip. Each of the communication links 127-2, 127-3, etc., is similar to communication link 127. The first semiconductor chip and the second semiconductor chip may be mounted on the same substrate in a manner as shown in FIG. 1. The first semiconductor chip in the second semiconductor chip may be cut from the same wafer.

Thus, all or a portion of the first communication circuit 171-1 may be configured as a first semiconductor chip. In such an instance, the active inductors 181-1 and 181-2 and corresponding one or more capacitors are disposed on the first semiconductor chip. The first semiconductor chip can be configured to include any number of transceivers and corresponding circuitry (such as similar to communication circuit 171-1).

Additionally, note that all or a portion of the communication circuit 171-2 may be configured as a second semiconductor chip. In such an instance, the active inductors 191-1 and 191-2 and corresponding one or more capacitors are disposed on a second semiconductor chip. The second semiconductor chip can be configured to include any number of transceivers and corresponding circuitry (such as similar to communication circuit 171-2). Thus, communication system 100 and corresponding communication link between each set of transceivers supports parallel and bidirectional conveyance of data.

As further discussed herein, settings of the inductances associated with active inductors as discussed herein can be achieved in any suitable manner. For example, the first active inductor 181-1 may be fabricated to provide a first inductance value via trimming of at least one component in the first active inductor. The second active inductor 191-1 may be fabricated to provide the second inductance value via trimming of at least one component in the second active inductor. Any of the pairs of active inductors (such as 181-1 and 191-1, 181-2 and 191-2, 181-3 and 191-3, 181-4 and 191-4, etc.) can be trimmed in a similar manner to substantially match each other.

An example of signals associated with a data flow from the communication circuit 171-1 to the communication circuit 171-2 is shown in FIGS. 12A-12F.

Yet further, note that the circuit 191-1 can be configured to include the configuration management resource 141-1. The circuit 191-2 can be configured to include the configuration management resource 141-2.

As further discussed herein, the configuration management resource 141-2 supports tuning of the receiver circuitry 120-2 such that its peak bandpass filtering aligns with the corresponding carrier frequency used by the transmitter circuitry 130-1 to transmit communications over the communication link 127.

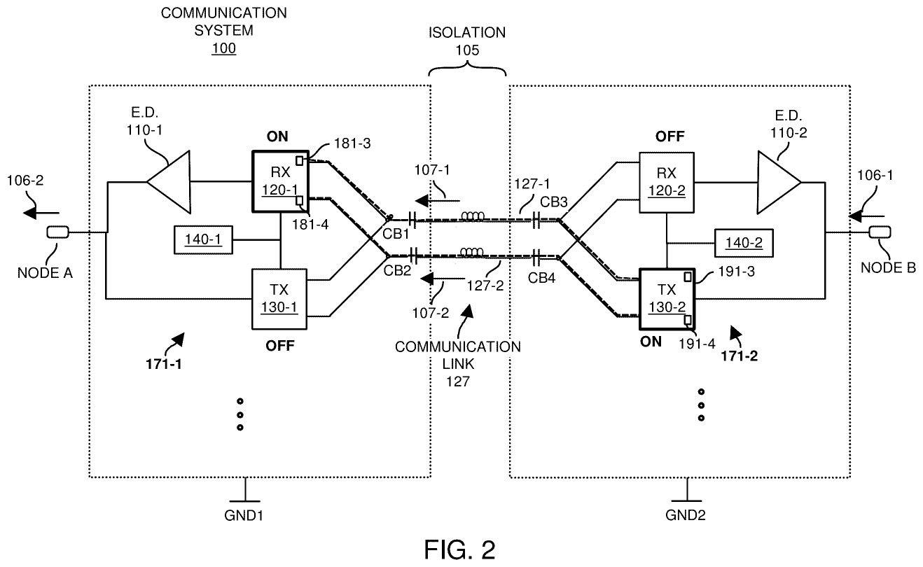

FIG. 2 is an example general diagram of a communication system and corresponding transmitter receiver pair operating in second data flow mode as discussed herein.

In FIG. 2, the controller 140-2 controls the transmitter 130-2 and corresponding circuitry to be in an ON-state while it controls the receiver 120-2 and corresponding circuitry to be in an OFF-state. This causes the communication circuit 171-2 to be set to a transmitter mode of communicating data to the communication circuit 171-1.

Further in FIG. 2, the controller 140-1 controls the transmitter 130-1 and corresponding circuitry to be in an OFF-state while it controls the receiver 120-1 and corresponding circuitry to be in an ON-state. This causes the communication circuit 171-1 to be set to a receiver mode of receiving data from the communication circuit 171-2.

More specifically, during operation in an upstream mode (FIG. 2) from the communication circuit 171-2 to the communication circuit 171-1, the communication circuit 171-2 receives signal 106-1 at node B. Via the active inductor 191-3 and other circuitry, the transmitter 130-2 converts the received input signal 106-1 into signal 107-1 communicated over the communication path 127-1 to the receiver 120-1. As previously discussed, communication path 127-1 includes series disposed DC blocking capacitor CB1 and DC blocking capacitor CB3. As their name suggests, these blocking capacitors allow the AC component of the signal 107-1 transmitted by the transmitter 130-2 to pass along the communication path 127-1 to the receiver 120-1. As further illustrated, the communication path 127-1 may include some amount of parasitic inductance.

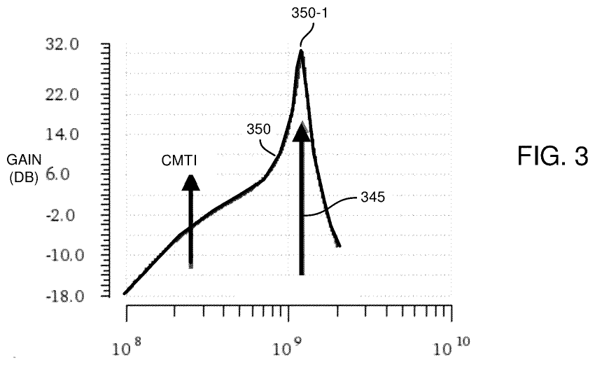

In general, the active inductor 191-3 controls a respective resonant frequency (or carrier frequency) of a modulation signal derived from the input signal 106-1; such a signal is communicated as signal 107-1 over the communication path 127-1. The receiver 120-1 includes a respective bandpass filter through which the received signal 107-1 passes to the envelope detector 110-1. The inductance of the active inductor 181-3 controls respective settings of the bandpass filter in the receiver 120-1. In one implementation, it is desired that the carrier frequency of the signal 107-1 as controlled by the inductance setting of the active inductor 191-3 substantially matches a peak bandpass carrier frequency setting associated with the receiver 120-1 and corresponding band-pass filter provide the best gain of the received signal 107-1. In one implementation, this disclosure includes substantially matching an inductance of the active inductor 191-3 to the inductance of the active inductor 181-3. An example is shown in FIG. 3 and following FIGS.

Referring again to FIG. 1, during operation in an upstream mode (FIG. 2) from the communication circuit 171-2 to the communication circuit 171-1, the communication circuit 171-2 receives signal 106-1 at node B. Via the active inductor 191-4 and other circuitry, the transmitter 130-2 converts the received input signal 106-1 into signal 107-2 communicated over the communication path 127-2 to the receiver 120-1. As previously discussed, communication path 127-2 includes series disposed DC blocking capacitor CB2 and DC blocking capacitor CB4. As their name suggests, these blocking capacitors allow the AC component of the signal 107-2 transmitted by the transmitter 130-2 to pass along the communication path 127-2 to the receiver 120-1. As further illustrated, the communication path 127-2 may include some amount of parasitic inductance.

FIG. 3 is an example diagram illustrating a transmitter carrier frequency and receiver band pass filter gain as discussed herein.

One solution to provide robust communications between the communication circuitry includes implementation of one or more active inductors to implement a high-order band-pass filter in the receiver 120-2, and implementation of one or more active inductors in the transmitter 130-1.

Via implementation of a substantially similar active-LC structure (such including one or more active inductors) on both the transmitter and receiver, the same resonant frequency behavior over process and temperature is achieved on both sides of the communication system 100. This active inductor matching and/or alignment of a resonant frequency 345 of the transmitted signal 105-1 to the resonant frequency or peak frequency 350-1 of the band-pass filter response 350 in the receiver maximizes the signal to noise/interference ratio at the output of the band-pass filter in the receiver, which increases robustness and response such that there is no need for blanking time blocks and its associated extra propagation delay time.

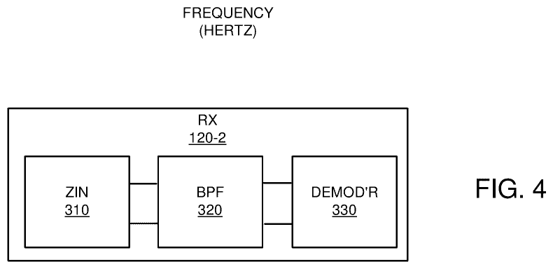

FIG. 4 is an example diagram illustrating the receiver as discussed herein.

In this instance, the receiver 120-2 associated with the communication circuit 171-2 include multiple components such as input impedance 310, bandpass filter 320, and the demodulator 330. Each receiver in the communication system 100 is implemented in a similar manner.

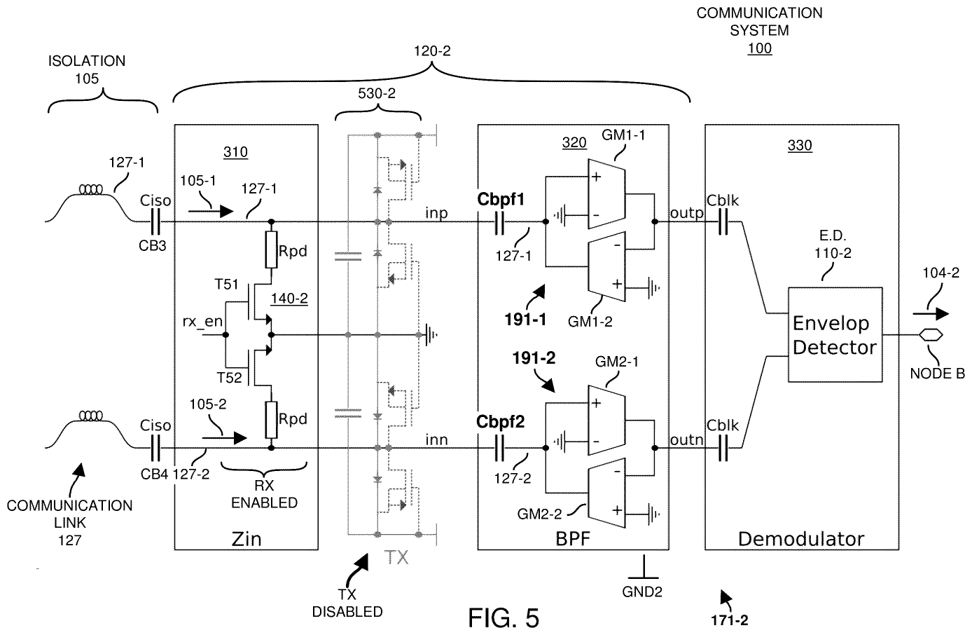

FIG. 5 is an example diagram illustrating a receiver circuit as discussed herein.

As previously discussed, the controller 140-2 and corresponding circuitry including transistor T51 and transistor T52 controls the operation of the receiver 120-2 in the receiver mode. The controller 140-2 deactivates the corresponding transistor circuitry 530-2.

As shown, the active inductor 191-1 and band-pass filter is implemented via a combination of transconductance amplifier GM1-1 and transconductance amplifier GM1-2 as well as capacitor Cbpf1. As previously discussed, the active inductor 191-1 is disposed in a respective band pass filter 320 associated with circuit path 127-1. Capacitor Cbpf1 is associated with band-pass filter 320. As its name suggests, the capacitor Cblk is a DC blocking capacitor. The inductance of the act of inductor 191-1 and the bandpass capacitor Cbpf1 controls a setting of the frequencies associated with the bandpass filter response 350 and, more specifically, which frequencies associated with the received signal 105-1 (set to resonant frequency 345 by the transmitter) are passed through to the envelope detector 110-2.

Similarly, the active inductor 191-2 and band-pass filter is implemented via a combination of transconductance amplifier GM2-1 and transconductance amplifier GM2-2 as well as capacitor Cbpf2. As previously discussed, the active inductor 191-2 is disposed in a respective band pass filter 320 associated with circuit path 127-2. Capacitor Cbpf2 is associated with band-pass filter 320. As its name suggests, the capacitor Cblk is a DC blocking capacitor. The inductance of the active inductor 191-2 and the bandpass capacitor Cbpf2 controls a setting of the frequencies associated with the bandpass filter response 350 and, more specifically, which frequencies associated with the received signal 105-2 (set to resonant frequency 345 by the transmitter) are passed through to the envelope detector 110-2. As previously discussed, the inductance of the active inductor 181-2 in the transmitter 130-1 defines a resonant frequency of a resonant circuit path coupled to the communication link 127-2. Further, the inductance of the active inductor 191-2 defines a bandpass filter response 350 of bandpass filter 320 coupled to the communication link 127-2 in the communication circuit 171-2.

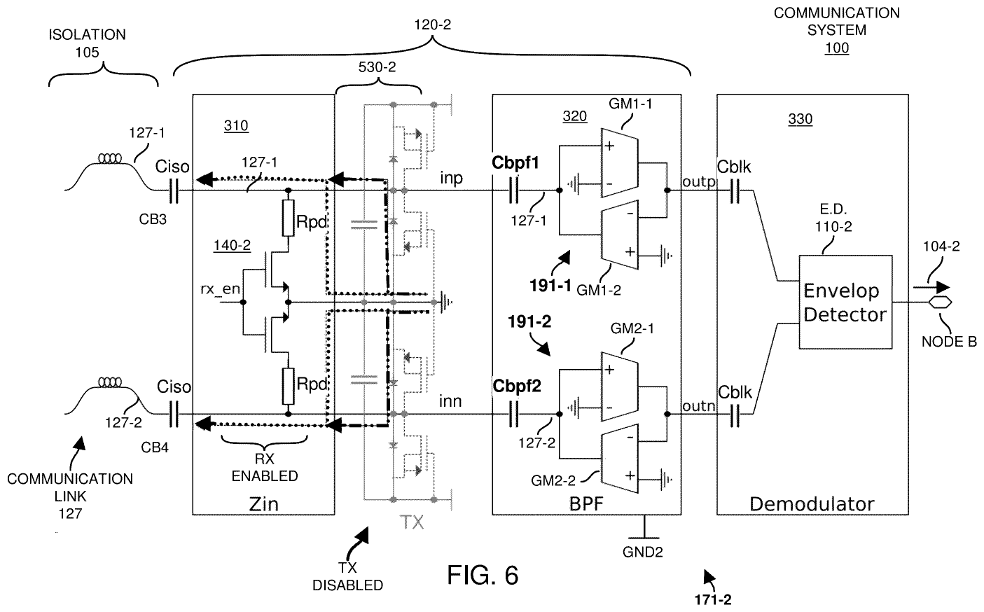

FIG. 6 is an example diagram illustrating a displacement current dominant paths during the rising edge of a receiver ground of communication circuit 171-2 with respect to a transmitter ground of communication circuit 171-1 as discussed herein.

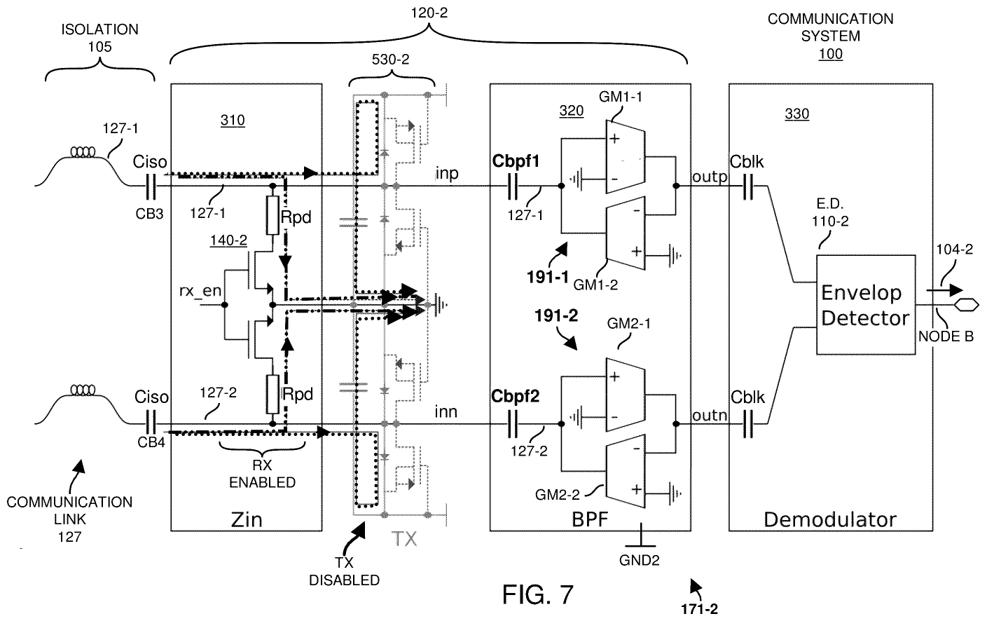

It should be noted that the bi-directionality of the proposed solution of communication circuitry (of communication system 100) helps to contain/stir the CMT (Common Mode Transistor) displacement current under a well-defined path to improve CMT robustness. For example, FIG. 6 illustrates flow of currents from the receiver 120-2 through the differential communication link 127 when the ground reference voltage GND2 is substantially greater than the ground reference voltage GND1. FIG. 7 illustrates flow of currents from the transmitter 130-1 through the communication link 127 to the receiver 120-1 when the ground reference voltage GND1 is substantially greater than the ground reference voltage GND2.

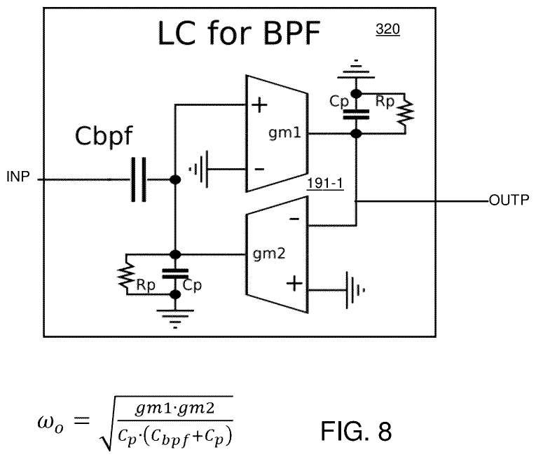

FIG. 8 is an example diagram illustrating an LC element used for creating a bandpass filter as discussed herein.

As previously discussed, the communication system 100 is a capacitive coupling communication system implementing one or more active inductors to provide improved conveyance of data from a first communication circuit to a second communication circuit over a communication link.

In one implementation, the bandpass filter center frequency is basically defined by the LC element associated with the band-pass filter as depicted in FIG. 8. This structure has center or peak band-pass frequency defined by the equation 1.

$${ω}_{o} = \sqrt{\frac{gm 1 \cdot gm 2}{{C}_{p} \cdot ( {C}_{bpf} + {C}_{p} )}} \qquad ( 1 )$$

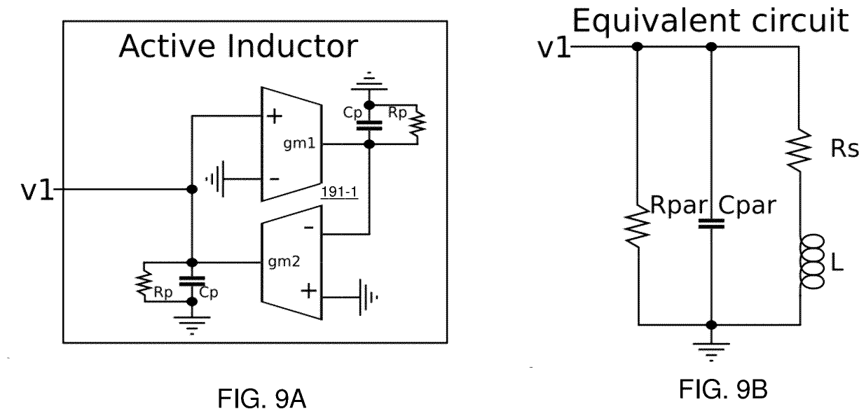

FIG. 9A is an example diagram illustrating an active inductor as discussed herein. Removal of the capacitor Cbpf from the bandpass filter results in the circuit as shown in FIG. 9A. The circuit in FIG. 9A maps to the equivalent circuit in FIG. 9B.

FIG. 9B is an example diagram illustrating an equivalent circuit of the active inductor of FIG. 9A as discussed herein.

$${R}_{par} = {R}_{p} \qquad ( 2 )$$

$${R}_{S} = \frac{1}{gm 1 \cdot gm 2 \cdot {R}_{p}} \qquad ( 3 )$$

$${C}_{par} = {C}_{p} \qquad ( 4 )$$

$$L = \frac{{C}_{p}}{gm 1 \cdot gm 2} \qquad ( 5 )$$

The resonant frequency of the equivalent circuit is defined by the square root of 1/LC, which in this case is defined by equation (6).

$${ω}_{o} = \sqrt{( \frac{gm 1 \cdot gm 2}{{C}_{p}} ) \frac{1}{{C}_{p}}} \qquad ( 6 )$$

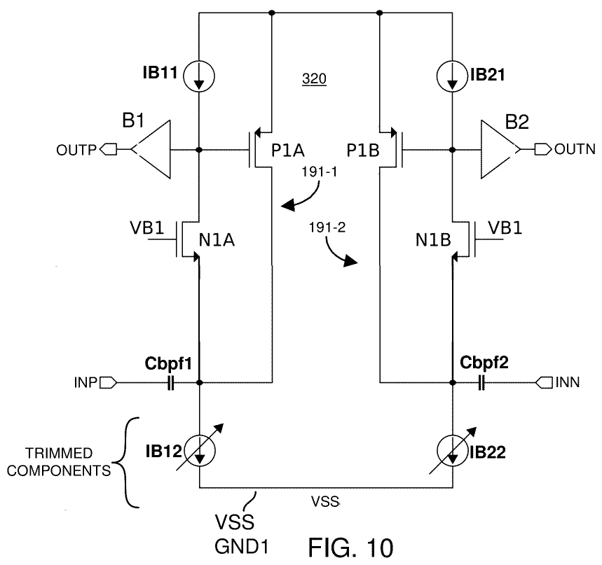

The receiver architecture as discussed herein allows the increase of the filter order by cascading more filters in series with the first or by tuning the quality factor of the active inductor. The active inductor architecture is shown in FIG. 10 below, connected to the positive input (inp) it can be seen the respective Cbpf capacitor and the back-to-back transconductors, implemented by N1A (gm1 or GM1-1) and P1A (gm2 or GM1-2). The gyrator output is buffered by the buffer blocks, which can be implemented as a source follower for example. The whole structure is symmetrically repeated for the negative input (inn).

FIG. 10 is an example diagram illustrating a generator architecture used for an active inductor implementation as discussed herein.

In this example embodiment, the implementation of the band-pass filter 320 includes capacitors Cbpf1 and Cbpf2, current source IB11, buffers B1 and B2, transistors P1A, P1B, N1A, N1B, and variable current sources IB21 and IB22. The variable current sources IB21 and IB22 can be trimmed to change the respective inductance associated with each of the active inductor implemented in the bandpass filter 320.

FIG. 11 is an example diagram illustrating a demodulator implementation as discussed herein.

The differential output of the band-pass filter 320 is fed into the demodulator block, shown in FIG. 11, which consists of a bias reference 1110, envelop detector 1120 (also 110-2 in FIG. 1), DC bias level 1130, and comparator 1140.

In one implementation, the fully differential envelop detector 1120 is based on a low power topology where the input transistors operate in weak inversion to exploit the non-linear Ix V transfer function characteristic of the NMOS and PMOS devices. Whenever a differential signal is applied into the INP and INN pins at time T1, the Vop voltage (envelope detect signal) drops, while the Von output voltage rises, as shown in FIGS. 12A-12F. The DC bias level sub-block 1130 is used to produce the same voltage level of Vop at the Vdcp node when no differential input signal is applied to the block input. Likewise, Vdcn has the same level as Von voltage (envelope detect signal) in no input condition.

The last sub-block of the demodulator is designed as one or more comparators 1140 using one NMOS and one PMOS differential pair connected to an active load, like in a rail-to-rail input amplifier. This allows the use of the full range of the differential signal produced by the previous sub-block at node Vop and Von. The comparator trip points (i.e., threshold level) can be defined by an extra corresponding current source Itrim connected to one of the output branches as depicted in FIG. 11.

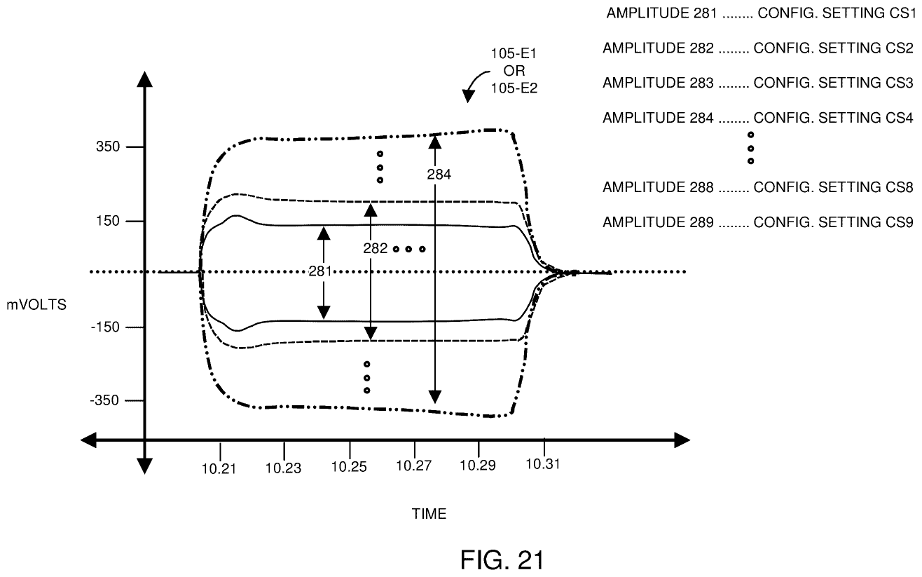

Additional details of using the output of the comparators 1140 as discussed in FIGS. 21 through 23.

FIGS. 12A, 12B, 12C, 12D, 12E, and 12F are an example timing diagrams of signals as discussed herein.

For example, graph 1210 of FIG. 12A illustrates timing of input signal 104-1, which is logic high between time T1 and T2 and otherwise logic low.

Graph 1220 of FIG. 12B illustrates timing associated with transmitted signal 105-1 and operation at a resonant frequency between time T1 and T2 when signal 104-1 is a logic high. Note that the resonant frequency associated with the transmitter 130-1 and corresponding transmitted signal 105-1 is substantially greater than the frequency of signal 104-1. Via monitoring of the signal 105-1, the envelope detector 110-2 (1120) detects the envelope 105-E1.

Graph 1230 of FIG. 12C illustrates timing associated with signal 105-2 and operation at a resonant frequency between time T1 and T2 when signal 104-1 is a logic high. Note again that the resonant frequency associated with the transmitter 130-1 and corresponding transmitted signal 105-2 is substantially greater than the frequency of signal 104-1. Via monitoring of the signal 105-2, the envelope detector 110-2 (1120) detects the envelope 105-E2.

The configuration management resource 141-2 monitors a respective magnitude of the signal 105-1 and or signal 105-2 for each of multiple different configuration settings of the receiver circuitry 120-2. The different configuration settings applied to the receiver circuitry 120-2 during testing enables the configuration management resource 141-2 to determine which of the corresponding settings results in a greatest magnitude of the envelope signals. This is discussed in more detail and FIGS. 21 through 23.

Graph 1240 a FIG. 12D illustrates the magnitude of voltage Vop over time. Logic low indicates detection of the envelope associated with signal 105-1 resonating at the resonant frequency of the transmitter 130-1.

Graph 1250 of FIG. 12E illustrates the magnitude of voltage Von over time. Logic high indicates detection of the envelope associated with signal 105-2 resonating at the resonant frequency of the transmitter 130-1.

Graph 1260 of FIG. 12F illustrates the generation and output of the corresponding signal 104-2 from the communication circuit 171-2. Thus, detection of the envelope 105-E1 between time T1 and T2 associated with the signal 105-1 and detection of the envelope 105-E2 associated with signal 105-2 between time T1 and T2 results in the envelope detector generating the output signal 104-2 from node B (whose magnitude is a logic high during conditions in which the envelopes are detected), which is a reproduction of the original signal 104-1.

FIG. 13 is an example diagram illustrating a transmitter circuit as discussed herein.

Implementation of the transmitter 130-1 (and related components) includes oscillator 1320, modulator 1330 (including logic AND1 and logic AND2), and drivers 1340.

As shown, the transmitter 130-1 receives signal 104-1 in a manner as previously discussed. Signal 104-1 is inputted to the inputs of the logic AND1 and logic AND2. The output of logic AND1 drives the sequence of drivers D11, D12, D13. Driver D13 outputs the corresponding signal 105-1 to the communication path 127-1 including the capacitor CB1. The output of logic AND2 drives the sequence of drivers D21, D22, D23. Driver D23 outputs the corresponding signal 105-2 to the communication path 127-2 including the capacitor CB2.

Thus, according to one configuration, the On-OFF Keying modulator 1330 is performed by a simple logic AND combination of the input signal 104-1, received from the input pin (node A), with the oscillator 1320 output signal defined as CLK and CLK_N. The CLK_N signal is 180 degrees out of phase with respect to CLK signal.

FIG. 14 is an example diagram illustrating an oscillator implementation as discussed herein.

Among several ways to implement oscillator 1320, one way is to implement a harmonic LC oscillator 1320-1 since it allows the use of the same active inductor structure to build the LC part of the LC oscillator. One example of oscillator 1320 is shown in FIG. 14, where the lossy part of the LC structure is represented by the parallel resistor R which can be compensated if a continuous oscillatory behavior is desired. This is where the cross-coupled transistors N2A and N2B are implemented to create a negative resistance, opposing the losses in the active inductor.

FIG. 15 is an example diagram illustrating an LC element used to create an oscillator as discussed herein.

In one embodiment, the RLC part of the oscillator 1320 shown in FIG. 14 is selected to be identical to the active inductor structure (active inductor 191-1) of the bandpass filter 320 of the communication circuit 171-2, with a single modification on the v1 input terminal connection, which is instead connected to VSS (GND1). The similarities are more clear when one compares the circuit in FIG. 15 to the circuit in FIG. 8.

The resonant frequency of the structure in FIG. 15 is also given by equation (1) as follows:

$${ω}_{o} = \sqrt{\frac{gm 1 \cdot gm 2}{{C}_{p} \cdot ( {C}_{bpf} + {C}_{p} )}} \qquad ( 1 )$$

which make the matching between the carrier frequency and the bandpass filter center frequency as high as possible. Thus, embodiments herein can include substantially matching an inductance of the active inductor 181-1 in the transmitter 130-1 to the active inductor 191-1 in the receiver 120-2. Matching of the transistor-level implementation of this oscillator 1320 is further shown in FIG. 16, which can be compared to FIG. 10 of the bandpass filter 320, which shows the matching of the active inductor 181-1 associated with the transmitter 130-1 to the active inductor 191-1 in the receiver 120-2 on the opposite side of the transmission channel (communication link 127).

FIG. 16 is an example diagram illustrating an oscillator as discussed herein.

As previously discussed, the modulator block 1330 is responsible for mixing up (modulating) the input signal 104-1 with the oscillator 1320 (such as depicted in FIG. 16) output via the AND1 and AND2 gates. The last stage (i.e., sequence of drivers D11, D12, D13 as well as sequence of drivers D21, D22, D23) completes the transmitter architecture (transmitter 130-1). The drivers 1340 can be configured as an inverter chain with a fixed ratio between the stages used to properly drive the capacitive load of the isolation channel, as shown in FIG. 13.

FIG. 17 is an example diagram illustrating trimming of a transmitter carrier frequency (resonant frequency) as discussed herein.

In one implementation, the inductance associated with the active inductor 181-1 (i.e., any transmitter active inductor) is adjusted such that, after trimming, the resonant frequency (carrier frequency 345) of transmitting the signal 105-1 aligns with the peak frequency 350-1 associated with the bandpass filter response 350.

Thus, from the testing point of view, this implementation allows transmitter/receiver fine tuning at ATE (Automated Test Equipment) by measuring propagation delay ON/OFF in a two-step process. When there is a mismatch between transmitter's carrier and receiver's bandpass filter resonant frequency, the amplitude of the signal passed on to the demodulator block will be smaller than expected. Trimming of a respective active inductor 181-1 (in a transmitter) to align the carrier frequency 345 to the peak frequency 350-1 ensures that the corresponding envelope detector receives a strong, noise free signal.

FIG. 18 is an example diagram illustrating trimming of the transmitter carrier and receiver bandpass resonance frequency as discussed herein.

As previously discussed in FIG. 10, an implementation of the receiver 120-2 includes a band-pass filter 320 and active inductors 191-1 and 191-2. The current sources IB12 and IB22 associated with active inductors are trimmable to control band-pass filter settings of the band-pass filter 320. For example, in one implementation, the fabricator of the communication system 100 sets trimming bits (or trimming code on x-axis) in graph 1800 in a 1st trimming step to control each of the magnitudes of the respective current sources IB12 and IB22 such that the active inductors and corresponding band-pass filter 320 is set to the appropriate band-pass filter settings.

When the envelope threshold level at the demodulator (comparator 114) is kept constant, the abovementioned attenuated signal on the demodulator input will be translated in a longer propagation delay. Hence, a perfect match between the carrier frequency of the transmitted signal 105-1 and signal 1-502 and band-pass resonant frequency is achieved at the minimum ON propagation delay, as shown in FIG. 18.

Note the shift of the carrier frequency (such as by adjusting trim settings of current sources IB12 and IB22) associated with the transmitted signal 105 in FIG. 17 towards the band-pass resonant frequency (e.g. center frequency of band-pass filter 320) is shown by way of a non-limiting example; the trimming process could be carried out the other way around such as by shifting the band-pass filter center frequency such that the peak 350-1 (such as center frequency) of the band-pass filter substantially aligns with the resonant frequency (carrier frequency) of the transmitter 130-1 and corresponding signals 105. Thus, shifting the band-pass resonant frequency toward the carrier frequency will produce the same effect of desired tuning as shown in FIG. 19.

FIG. 19 is an example diagram illustrating trimming by shifting a bandpass filter resonance frequency as discussed herein.

In one implementation, as previously discussed, the inductance associated with the active inductor 191-1 (such as band-pass filter active inductor) and corresponding band-pass filter 320 is adjusted (via trimming of the respective active inductor 191-1) to shift the band-pass filter response 350 and corresponding resonant band-pass filter frequency (or center frequency of band-pass filter) such that the band-pass filter resonant frequency and corresponding peak 350-1 of receiving the signal 105-1 substantially aligns with the carrier frequency 345 (resonant frequency) of received signal 105-1.

When there is a mismatch between transmitter's carrier and receiver's bandpass filter resonant frequency, the amplitude of the signal passed on to the demodulator block will be smaller than expected. Trimming of the active inductor 191-1 to align the peak frequency 350-1 of the bandpass filter resonant frequency to the carrier frequency 345 of the corresponding transmitter and transmitted signal ensures that the envelope detector receives a strong as possible signal.

FIG. 20 is an example diagram illustrating a second step of trimming of the transmitter carrier and receiver bandpass resonance frequency as discussed herein.

As shown in FIG. 20, the threshold level (TL) of the envelope detector can be trimmed via varying the magnitude of the current source Itrim with different configuration settings in FIG. 11. The magnitude of the current associated with Itrim is set via trim bit settings and is used to balance the propagation delay ON and OFF as depicted in FIG. 20.

Yet further, note that measurements of the envelope signal 105-E1 (FIG. 12B) and/or envelope signal 105-E2 (FIG. 12C) can be used as a basis in which to tune the respective communication channel. Referring again to FIG. 11, note that the monitoring of the magnitude of the envelope signals associated with a respective channel such as between node A and node B (see FIG. 1) can occur in the digital domain. It may be desirable to include a respective fast analog-to-digital converter (ADC) (see FIG. 11) to convert the magnitude of the one or more envelope signals into a digital signal. The ADC may be configured to be fast enough to correctly convert the envelope signal with the ON time of the propagated signal. One way to implement a respective analog-to-digital converter is to implement multiple comparators as shown in FIG. 11 to determine a respective amplitude of the monitored envelope signal. The output signals from the collective group of comparators can be a digital coded value indicating a magnitude of the detected one or more envelope signals. If desired, the combination of the comparators can be configured to generate a respective thermometer code indicating the corresponding magnitude of the envelope signal at different times.

FIG. 21 is an example diagram illustrating a demodulator envelope output signal associated with different trim codes as discussed herein.

Examples herein include measuring the amplitude of the envelope signals associated with conveyance of communications over the capacitive coupled communication link to determine which of multiple possible configuration settings (resonant frequency settings controlled via application of trim codes) applied to the receiver circuitry 120-2 provides the best alignment of the peak frequency 350-1 associated with the bandpass filter response 350 of the receiver circuitry 120-2 to the carrier frequency 345 used by the transmitter circuitry 130-1 to transmit respective signals 105-1 and 105-2 over the communication link 127. (See FIG. 17).

In one implementation, the configuration management resource 141-2 adjusts the inductance associated with the active inductor 191-1 (i.e., any transmitter active inductor) or other suitable entity or component associated with the receiver 120-2 such that, after trimming or tuning, the resonant frequency (carrier frequency 345) of transmitting the signal 105-1 aligns with the peak frequency 350-1 associated with the bandpass filter response 350. In other words, examples herein include determining which of multiple different tested configuration settings of the peak frequency 350-1 provide the best reception of the signal 105 transmitted over the capacitive couple communication link 127 then using that best configuration setting for application to the capacitive coupled communication link and corresponding receiver.

Accordingly, examples herein include measurement of the envelope output amplitude of the respective one or more envelope signals 105-E1 and 105-E2 and adjusting the band-pass filter accordingly so that this amplitude of the corresponding envelope is always maximized.

In this example, the graph in FIG. 21 illustrates the different amplitude measurements associated with the envelope signal 105-E1 or envelope signal 105-E2 for each of multiple different tested configuration settings such as configuration settings CS1, CS2, CS3, . . . , CS8, CS9, etc.

For example, the configuration management resource 141-2 applies the different configuration settings CS1, CS2, CS3, . . . , CS8, CS9, etc., to test operation of the capacitive coupled communication link 127 and corresponding receiver.

In this example, application of the configuration setting CS1 causes the peak resonant frequency 350-1 associated with the receiver 120-2 to be a first resonant frequency value; application of the configuration setting CS2 causes the peak resonant frequency 350-1 associated with the receiver 120-2 to be a second resonant frequency value; application of the configuration setting CS3 causes the peak resonant frequency 350-1 associated with the receiver 120-2 to be a third resonant frequency value; application of the configuration setting CS4 causes the peak resonant frequency 350-1 to be a fourth resonant frequency value; and so on.

For each of the different applied configuration settings, the configuration management resource 141-2 implements amplitude monitoring of one or more envelope signals 105-E1 or 105-E2. Via amplitude monitoring, the configuration management resource 141-2 detects a respective performance of the capacitive coupled communication link 127 conveying communications for each of the applied configuration settings.

More specifically, application of the configuration setting CS1 to the receiver circuitry 120-2 results in the measured envelope being amplitude 281 corresponding to the first performance (worst performance) of the communication link 127 and corresponding transmitter/receiver to convey communications between the input of the output; application of the configuration setting CS2 to the receiver circuitry 120-2 results in the measured envelope being amplitude 282 corresponding to a second performance of the communication link 127 and corresponding transmitter/receiver to convey communications between the input of the output; application of the configuration setting CS3 to the receiver circuitry 120-2 results in the measured envelope being amplitude 283 corresponding to a third performance of the communication link 127 and corresponding transmitter/receiver to convey communications between the input of the output; application of the configuration setting CS4 to the receiver circuitry 120-2 results in a fourth performance (best performance) of the communication link 127 and corresponding transmitter/receiver to convey communications between the input of the output; and so on.

Based upon the amplitudes and corresponding performances in which the configuration setting CS 4 provides the best performance of largest magnitude envelope, the configuration management resource 141-2 selects the configuration setting CS4 amongst the applied configuration settings to control the operation of the capacitive coupled communication link based on the determined performances as indicated by the envelope amplitudes.

Thus, in one example, the configuration management resource 141-2 selects the corresponding configuration setting (such as trimming codes) associated with the maximum detected amplitude for controlling the peak resonant frequency associated with the bandpass filter of the receiver circuitry 120-2. In this example, as previously discussed, the amplitude 284 is detected as being the maximum detected amplitude amongst all the different configuration settings. In such an instance, the configuration management resource 141-2 selects the configuration setting CS4 in which to apply to the receiver 120-2.

The graph of FIG. 21 illustrates amplitude monitoring implemented by the configuration management resource 141-2. The amplitude monitoring includes generation of a respective peak-to-peak measurements (such as amplitude 281, amplitude 282, amplitude 283, etc.) associated with the communications conveyed over the first capacitive coupled communication link for each of the applied configuration settings (CS1, CS2, CS3, CS4, etc.).

Note further that the configuration management resource 141-2 can be configured to the test operation of the capacitive coupled communication link 127 and corresponding transmitter/receiver during uninterrupted transmission of data over the capacitive coupled communication link 127 from a transmitter circuit to a receiver circuit.

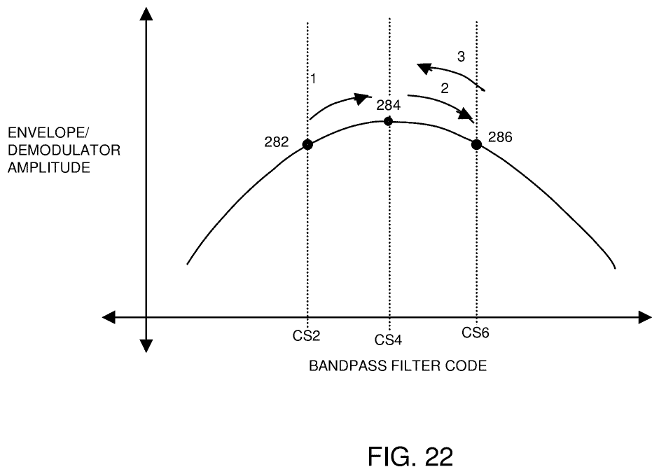

As further discussed in the following FIG. 22, the configuration management resource 141-2 can be configured to implement a control function to repeatedly test and then select the appropriate bests configuration setting and peak resonant frequency of the receiver circuitry 120-2 such that the communication link 127 operates at peak performance. As previously discussed, selection of the best configuration setting causes the peak resonant frequency of the receiver circuit 120-2 to align with the carrier frequency used by the transmitter circuitry 130-1 to transmit the corresponding signal 105.

FIG. 22 is an example diagram illustrating control operation of tweaking the carrier frequency and/or resonant frequency associated with the capacitive communication link and corresponding transmitter-receiver to provide optimal conveyance of data as discussed herein.

The so-called Perturb and Observe (P&O) method as shown in FIG. 22 includes measuring the envelope amplitude for each of multiple different tested resonant frequency settings and selecting the best resonant frequency setting (configuration setting) that provides (via amplitude monitoring of the envelope signal) the maximum sized envelope.

For example, as shown in FIG. 22, the configuration management resource 141-2 initially applies the configuration setting CS2 to the receiver circuitry 120-2. The configuration management resource 141-2 detects the envelope amplitude (of signal 105-E1 and/or 105-E2) associated with the configuration settings CS2 as being amplitude 282.

In further testing for the best possible configuration setting, the configuration management resource 141-2 applies the configuration setting CS4 to the receiver circuitry 120-2. The configuration management resource 141-2 detects the envelope amplitude associated with the configuration settings CS4 as being amplitude 284.

The configuration management resource 141-2 does not yet know if the configuration setting CS4 provides the greatest or maximum amplitude. In such an instance, the configuration management resource 141-2 applies the configuration setting CS6 to the receiver circuitry 120-2. The configuration management resource 141-2 detects that the amplitude 286 is less than the amplitude 284. In such an instance, the configuration management resource 141-2 reverts back to applying the configuration setting CS4 (controlling the resonant frequency of the receiver and corresponding peak resonant frequency value) to the receiver circuitry because configuration setting CS4 provides the highest magnitude of the envelope.

Further in this example, note that application of the configuration setting CS4 results in a first time delay of conveying the communications over the capacitive coupled communication link 127; application of the configuration setting CS2 results in a second time delay of conveying the communications over the first capacitive coupled communication link. In one aspect as discussed herein, note that the configuration setting CS4 provides better performance because the first time delay of conveying communications is less than the second time delay of conveying communications over the capacitive coupled communication link. In other words, the configuration setting such as CS4 provides the maximum envelope amplitude and also provides the shortest delay time of conveying the communications over the capacitive coupled communication link 127. The configuration setting such as CS2 provides a less than maximum envelope amplitude and also provides a longer delay time of conveying the communications over the capacitive coupled communication link 127.

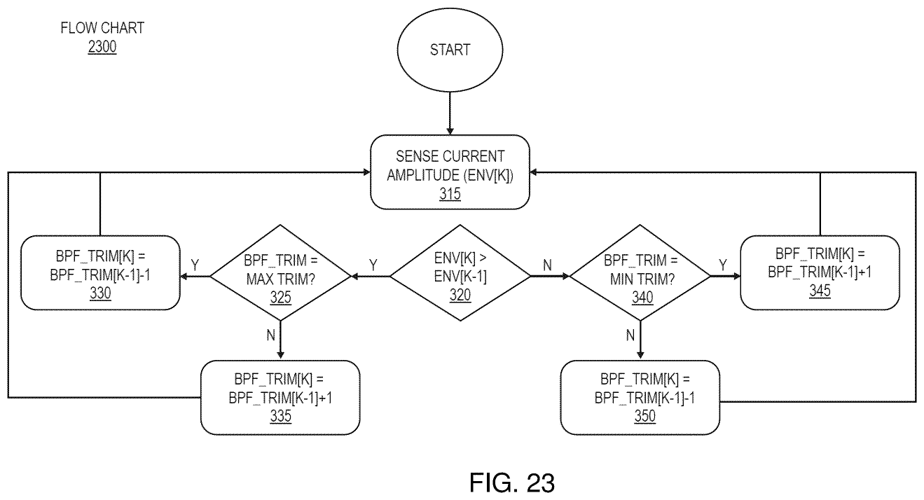

FIG. 23 is an example diagram illustrating an example of trim control as discussed herein.

The method as shown in flowchart 2300 can be implemented by the configuration management resource 141-2 or other suitable entity to control the corresponding peak resonant frequency for configuration settings associated with the receiver circuitry 120-2.

In processing operation 315, the configuration management resource 141-2 measures corresponding amplitude of an envelope signal (such as signal 105-E1 and/or signal 105-E2) in a manner as previously discussed for a given configuration setting.

In processing operation 320, the configuration management resource 141-2 determines whether or not the most recently measured amplitude of the envelope signal for the current tested amplitude setting is greater or less than the amplitude of the envelope signal for the prior tested configuration setting a corresponding detected amplitude. If so, processing continues at operation 325. If not, processing continues at operation 340.

In processing operation 325, the configuration management resource 141-2 determines if the corresponding setting is a maximum trim value associated with the bandpass filter. If so, flow continues at operation 330. If not, flow continues in operation 335.

In processing operation 330, the configuration management resource 141-2 sets the trim of the bandpass filter associated with the receiver circuitry 120-2 to the prior trim setting.

Alternatively, in processing operation 335, the configuration management resource 141-2 sets the trim of the bandpass filter associated with the receiver circuitry 120-2 to the current trim setting.

In processing operation 340, the configuration management resource 141-2 determines if the corresponding setting is a minimum trim value associated with the bandpass filter. If so, flow continues at operation 345. If not, flow continues in operation 350.

In processing operation 350, the configuration management resource 141-2 sets the trim of the bandpass filter associated with the receiver circuitry 120-2 to the prior trim setting.

Alternatively, in processing operation through 345, the configuration management resource 141-2 sets the trim of the bandpass filter associated with the receiver circuitry 120-2 to the current trim setting.

In this manner, the configuration management resource 141-2 can be configured to continuously monitor the envelope and apply the appropriate configuration setting to provide the maximum sized envelope associated with signal 105-E1 and/or signal 105-E2.

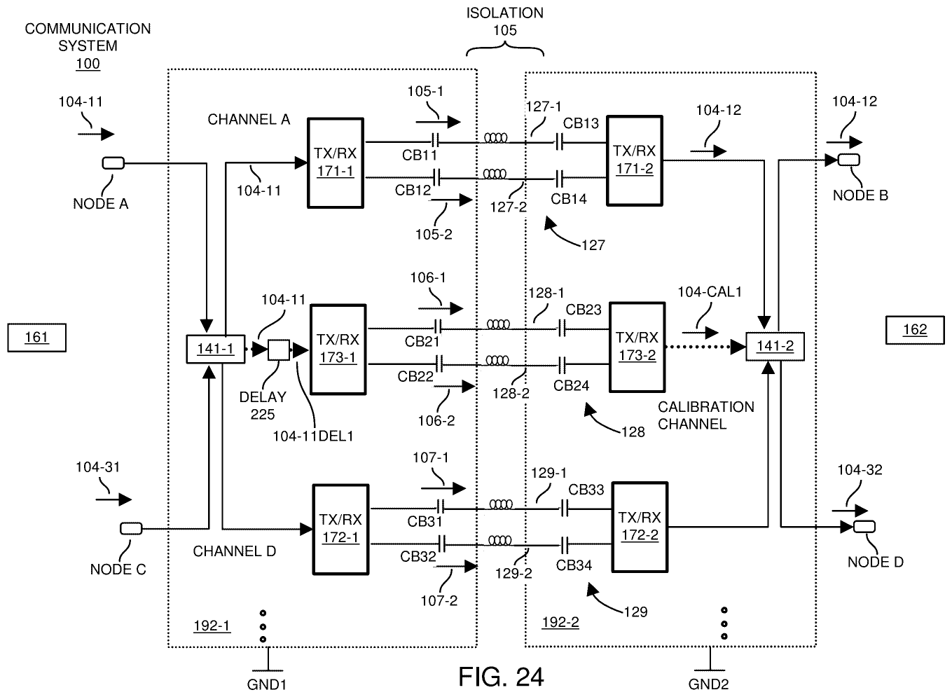

FIG. 24 is an example diagram illustrating a mode of calibrating a calibration channel as discussed herein.

In this example, the communication system 100 includes multiple communication channels including a supplemental channel such as a calibration channel 128 to support tuning of the channel A and channel D and corresponding conveyance of communications between a first entity such as resource 161 and a second entity such as resource 162. In such an instance, the communication system includes channel A (channel 127), calibration channel 128, and channel D (channel 129).

Communication system 100 includes circuit 192-1 such as a circuit board of components, semiconductor die, semiconductor chip, etc., including communication circuit 171-1, communication circuit 172-1, communication circuit 173-1, and so on.

Communication system 100 includes circuit 192-2 such as a circuit board of compliments, semiconductor die, semiconductor chip, etc., including communication circuit 171-2, communication circuit 172-2, communication circuit 173-2, and so on.

Further in this example, Channel A includes circuitry such as communication circuit 171-1 as well as communication circuit 171-2 and corresponding capacitive coupled communication link 127 there between. As previously discussed, the communication circuit 171-1 can be configured to operate in a transmit mode or a receive mode. The communication circuit 171-2 can be configured to operate in a transmit mode or a receive mode.

Channel A includes a capacitive coupled communication link 127 extending between the communication circuit 171-1 and the communication circuit 171-2. The capacitive coupled communication link 127 includes a first communication path 127-1 and a second communication path 127-2 to convey respective communications (such as the differential communications) between the communication circuit 171-1 and the communication circuit 171-2.

Further, as previously discussed, the communication path 127-1 includes serial connectivity of the capacitor CB11 and the capacitor CB13 between the communication circuit 171-1 and the communication circuit 171-2. The communication path 127-2 includes serial connectivity of the capacitor CB12 and capacitor CB14 between the communication circuit 171-1 and the communication circuit 171-2. Inclusion of the capacitors in the serial communication path blocks DC signal components and allows passing of the AC signal components.

As previously discussed, the communication circuit 171-1 is referenced with respect to ground reference voltage GND1. The communication circuit 171-2 is referenced with respect to the ground reference voltage GND2. The capacitive coupling associated with the channel A enables reliable conveyance of data between the communication circuit 171-1 and the communication circuit 171-2 even though they are connected to different ground reference potentials.

Channel D includes circuitry such as communication circuit 172-1 as well as communication circuit 172-2. The communication circuit 172-1 can be configured to operate in a transmit mode or a receive mode. The communication circuit 172-2 can be configured to operate in a transmit mode or a receive mode.

Channel D includes a capacitive coupled communication link 129 extending between the communication circuit 172-1 and the communication circuit 172-2. The capacitive coupled communication link 129 includes a first communication path 129-1 and a second communication path 129-2 to convey respective communications (such as the differential communications) between the communication circuit 172-1 and the communication circuit 172-2.

Further, as previously discussed, the communication path 129-1 includes serial connectivity of the capacitor CB31 and the capacitor CB33. The communication path 129-2 includes serial connectivity of the capacitor CB32 and capacitor CB34.

Inclusion of the capacitors in the serial communication path blocks DC signal components and allows passing of the AC signal components. Communication circuit 172-1 is referenced with respect to ground reference voltage GND1. The communication circuit 172-2 is referenced with respect to the ground reference voltage GND2. The capacitive coupling associated with the channel D enables reliable conveyance of data between the communication circuit 172-1 and the communication circuit 172-2 even though they are connected to different ground reference potentials. The ground reference potentials may experience transient conditions in which they vary greatly over time with respect to each other.

The calibration channel 128 includes circuitry such as communication circuit 173-1 as well as communication circuit 173-2. The communication circuit 173-1 can be configured to operate in a transmit mode or a receive mode. The communication circuit 173-2 can be configured to operate in a transmit mode or a receive mode.

The calibration channel 128 includes a differential capacitive coupled communication link extending between the communication circuit 173-1 and the communication circuit 173-2. The capacitive coupled communication link associated with the calibration channel 128 includes a first communication path 128-1 and a second communication path 128-2 to convey respective communications (such as the differential communications) between the communication circuit 173-1 and the communication circuit 173-2.

Further, in a similar manner as previously discussed, the communication path 128-1 includes serial connectivity of the capacitor CB21 and the capacitor CB23. The communication path 128-2 includes serial connectivity of the capacitor CB22 and capacitor CB24. Inclusion of the capacitors in the serial communication path blocks DC signal components and allows passing of the AC signal components. The communication circuit 173-1 is referenced with respect to ground reference voltage GND1. The communication circuit 173-2 is referenced with respect to the ground reference voltage GND2. The capacitive coupling associated with the channel D enables reliable conveyance of data between the communication circuit 172-1 and the communication circuit 172-2 even though they are connected to different ground reference potentials.

This example of the communication system 100 includes configuration management resource 141-1 as well as configuration management resource 141-2. As further discussed, the configuration management resources can be used to calibrate operation of each of the different channels including the Channel A, channel D, and the calibration channel 128. Presence of the calibration channel such as a supplemental channel with respect to the channel A and channel D enables in-field calibration of the communication system 100 without having to discontinue conveyance of communications from one entity (resource 161) to another using the corresponding communication channels (resource 162). In other words, the communication system 100 and corresponding channels can be calibrated without interrupting conveyance of data from a first entity coupled to node A and node C and a second entity coupled to node B and node D.

Note that the configuration management resource 141-1 can be configured as configuration management hardware, configuration management software, or a combination of configuration manager hardware and configuration management software; the communication management resource 141-2 can be configured as configuration management hardware, configuration management software, or a combination of configuration management hardware and configuration management software.

Note further that the self-calibration such as trimming process for the capacitor-coupling digital isolator as discussed herein can be embedded in the communication system 100 (via configuration management resource 141-1 and configuration management resource 141-2) to reduce or eliminate capacitance or inductance mismatch drift over lifetime.

In this example, circuit calibration is achieved in a seamless way via use of spare/idle channel (calibration channel 128) present in the communication system 100. The proposed calibration process or procedure as discussed herein can be broken down to include two phases (such as a first phase and a second phase), so that the data path (such as between node A and node B) in the application is never interrupted or distorted, thus providing uninterrupted communications from node A to node B without any downtime for self-calibration.

As further discussed herein, in the first phase of self-calibration, the configuration management resource 141-2 applies different configuration settings to the calibration channel 128 to determine which settings support optimal conveyance of communications over the calibration channel 128; in the second phase of self-calibration, the configuration management resource 141-2 applies different configuration settings to the channel A and corresponding circuitry to determine which settings support optimal conveyance of communications over the channel A. Accordingly, implementation of both of the phases of the two-phase calibration technique as discussed herein results in calibration or tuning of both the calibration channel 128 and the Channel A. Each of the other channels associated with communication system 100 can be calibrated in a similar manner.

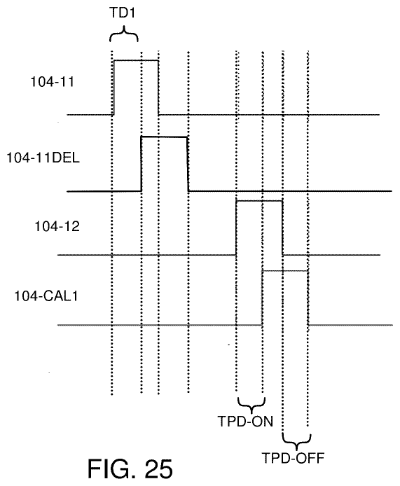

As a more specific example, for each different possible configuration setting of the communication circuit 173-2, in a first phase (phase A) of circuit calibration, the pulse inserted in pin INA (a.k.a., node A) is transmitted to pin OUTA (a.k.a., node B) through the transceiver 171-1 over the capacitive coupled communication link 127 to the communication circuit 171-2 (active channel), while a delayed copy of this pulse (signal 104-11) is also transmitted via the transceiver such as communication circuit 173-1 over the communication link 128. Sometime after the transmission of the pulse such as signal 104-11, the self-calibration engine such as configuration management resource 141-2 associated with the circuit 192-2 measures the time difference between the signal 104-12 received via channel A and the time delayed signal 104-11DEL1 received over the calibration channel such as signal 104-CAL1. This relative time difference between these signals is stored as the TPD-ON and TPD-OFF for the calibration of the calibration channel 128 is shown in FIG. 25.

By repeating this procedure for the next pulse inserted in note A and using a different trimming code applied to the calibration channel 128, the configuration management resources determine the best setting associated with the calibration channel 128. Thus, the self-calibration engine as described herein simply uses the pulses of the running application to calibrate an idle/spare channel without interrupting or disturbing the application data between node A and node B.

At the end of the first phase, an idle/spare channel such as the calibration channel 128 is fully optimized based on the application of a respective configuration setting providing the shortest delay time of conveying communications over the calibration channel 128, but the channel that is being used to actually carry the data (channel A in this example) was not yet calibrated. As further discussed herein, the second phase of calibration is very similar to the first phase of calibration, with the exception that the role of calibration and active channels are swapped, as depicted in Error! Reference source not found. This step is desirable to keep the seamless operation of the system from the INA to OUTA pins perspective.

Referring again to FIG. 24, note that the configuration management resource 141-1 (such as a self-calibration engine) on the circuit 192-1 (such as a first semiconductor chip, die, etc.) can be configured to operate as a master device that is responsible for initiating the whole self-trimming process by starting phase A of the calibration process and sending the first pulse over channel A as well as the calibration channel 128.

In one example, the first pulse (such as an instance of the signal 104-11) received by the configuration management resource 141-2 over the calibration channel 128 wakes up the configuration management resource 141-2 (such as a self-calibration engine) disposed on the circuit 192-2. Since the number of trimming bits to adjust the configuration of each communication circuit is finite, there is a fixed amount of needed pulse to conclude the whole process. For instance, assume implementation of a binary search algorithm. In such an instance, the binary search algorithm in each channel needs N-bits+1 steps to be fully calibrated and the transition between Phase A and B should happen exactly at the middle of this process. That means a total of 2*N-bits+2 pulses may be used to fully calibrate channel A. After N-bits+1 pulses are used to calibrate the calibration channel 128, there is a switchover to calibratingthe channel A. Both sides will know that it is time to swap the data flow to keep the seamless operation, at the end of the 2*N-bits+2 both sides will also know that the calibration step for CHA is over and the original data flow between INA and OUTA pins can be restored.

As a more specific example, assume that the communication system 100 provides conveyance of data between the resource 161 and the resource 162 via input of signal 104-11 from resource 161 into node A and input of signal 104-31 into node C. In a manner as previously discussed, the channel A conveys corresponding communications between the communication circuit 171-1 over the capacitive coupled communication link 127 to the communication circuit 171-2. The communication circuit 171-2 converts the received differential signal into signal 104-12 outputted at the node B. See a prior discussion of circuit operation in the prior FIGS. and description.

In one example, to calibrate the calibration channel 128 in a manner as previously discussed, the configuration management resource 141-1 and the configuration management resource 141-2 test application of different configuration settings to the communication circuit 173-1 and/or communication circuit 173-2 in order to align the peak frequency 350-1 of the bandpass associated with the communication circuit 173-2 to the carrier frequency of signals transmitted by the communication circuit 173-1 (see carrier frequency 345 in FIG. 19 showing initial misalignment and then subsequent alignment of the peak frequency 350-1 based on adjusting the receiver circuit).

In general, as further discussed below in the detailed examples, the configuration management resource 141-2 determines which particular configuration setting of multiple tests and configuration settings applied to the communication circuit 173-2 provides the shortest time delay between the signal inputted to the communication circuit 173-1 and the corresponding signal outputted by the communication circuit 173-2. That particular configuration setting associated with the shortest time delay provides best alignment of the peak frequency 350-1 of the band-pass filter response 350 associated with the communication circuit 173-2 to the carrier frequency used to transmit signals from the communication circuit 173-1.

### Testing of Configuration Setting #1

To calibrate the calibration channel 128, the configuration management resource 141-2 first applies a first configuration setting to control a resonant frequency (such as a peak resonant frequency 351) of the communication circuit 173-2 to a first resonant frequency value to receive the communications over the calibration channel 128. The combination of the communication management resource 141-1 and the communication management resource 141-2 then perform a test with respect to the first configuration setting and corresponding applied first resonant frequency value under test. For example, for the first configuration setting (such as a first setting of the peak frequency 350-1 associated with the communication circuit 173-2), the configuration management resource 141-1 communicates a delayed rendition of the signal 104-11 over the calibration channel 128. The delayed rendition such as signal 104-11DEL1 is a delayed copy of the signal 104-11. More specifically, the configuration management resource 141-1 implements the delay circuit 225 to delay the signal 104-11 inputted to the communication circuit 173-1. Assume that the delay circuit 225 implements a 10 nanosecond delay (or other suitable value) to delay the signal 104-11 to produce the delayed signal 104-11DEL1. In such an instance, the communication circuit 173-1 uses the delayed signal 104-11DEL1 to produce the respective differential signal 106 (combination of signal 106-1 and signal 106-2) conveyed over the calibration channel 128 to the communication circuit 173-2. As previously discussed, while operating in the receiver mode, the communication circuit 173-2 converts the received differential signal into the corresponding signal 104-CAL1. As shown in FIG. 25, the configuration management resource 141-2 then determines a time difference between receiving the signal 104-12 over channel A and receiving the signal 104-CAL1 over the calibration channel 128. This can include determining a difference between a rising edge of the signal 104-12 and the rising edge of the signal 104-CAL1, resulting in the measurement of TPD-ON. Additionally or alternatively, this can include determining a time difference between a falling edge of the signal 104-12 and the falling edge of the signal 104-CAL1, resulting in the measurement of TPD-OFF. The communication management resource 141-2 stores first delay information such as TPD-ON and/or TPD-OFF for the first configuration setting (first resonant frequency setting) applied to the communication circuit 172-2. Assume that the detected time delay is 30 nanoseconds. This means that the delay associated with the calibration channel 128 is 30 nanoseconds minus 10 nanoseconds (from the delay circuit 225) equal to 20 nanoseconds for the first test configuration setting CS1.

### Testing of Configuration Setting #2

To calibrate the calibration channel 128, in a second time duration following the first time duration above, the configuration management resource 141-2 applies a second configuration setting CS2 to control a peak resonant frequency of the communication circuit 173-2 to a second resonant frequency value to receive the communications over the calibration channel 128. The combination of the communication management resource 141-1 and the communication management resource 141-2 then perform a test with respect to the second configuration setting and second resonant frequency value. For example, for the second configuration setting (such as a second setting of the peak frequency 350-1 associated with the communication circuit 173-2), the configuration management resource 141-1 communicates a delayed rendition of the signal 104-11 over the calibration channel 128. The delayed rendition such as signal 104-11DEL1 is a delayed copy of the signal 104-11. More specifically, the configuration management resource 141-1 implements the delay circuit 225 to delay the signal 104-11 inputted to the communication circuit 173-1. Assume that the delay circuit 225 implements a 10 nanosecond delay (or other suitable value) to delay the signal 104-11 to produce the delayed signal 104-11DEL1. In such an instance, the communication circuit 173-1 uses the delayed signal 104-11DEL1 to produce the respective differential signal 106 (combination of signal 106-1 and signal 106-2) conveyed over the calibration channel 128 to the communication circuit 173-2. As previously discussed, while operating in the receiver mode, the communication circuit 173-2 converts the received differential signal into the corresponding signal 104-CAL1. As shown in FIG. 25, the configuration management resource 141-2 then determines a time difference between receiving the signal 104-12 and receiving the signal 104-CAL1 for the second configuration setting CS2. This can include determining a difference between a rising edge of the signal 104-12 and the rising edge of the signal 104-CAL1, resulting in the measurement of TPD-ON. Additionally or alternatively, this can include determining a time difference between a falling edge of the signal 104-12 and the falling edge of the signal 104-CAL1, resulting in the measurement of TPD-OFF. The communication management resource 141-2 stores second delay information such as TPD-ON and/or TPD-OFF for the second configuration setting CS2 (second resonant frequency setting) applied to the communication circuit 172-2. Assume that the time delay is 25 nanoseconds. This means that the delay associated with the calibration channel 128 is 25 nanoseconds minus 10 nanoseconds (from the delay circuit 225) equal to 15 nanoseconds for the second configuration setting CS2.

### Testing of Configuration Setting #3

To calibrate the calibration channel 128, in a third time duration following the second time duration, the configuration management resource 141-2 applies a third configuration setting CS3 to control a resonant frequency of the communication circuit 173-2 to a third resonant frequency value to receive the communications over the calibration channel 128. The combination of the communication management resource 141-1 and the communication management resource 141-2 then perform a test with respect to the third configuration setting and corresponding third resonant frequency value. For example, for the third configuration setting CS3 (such as a third setting of the peak frequency 350-1 associated with the communication circuit 173-2), the configuration management resource 141-1 communicates a delayed rendition of the signal 104-11 over the calibration channel 128. The delayed rendition such as signal 104-11DEL1 is a delayed copy of the signal 104-11. More specifically, the configuration management resource 141-1 implements the delay circuit 225 to delay the signal 104-11 inputted to the communication circuit 173-1. Assume that the delay circuit 225 implements a 10 nanosecond delay (or other suitable value) to delay the signal 104-11 to produce the delayed signal 104-11DEL1. In such an instance, the communication circuit 173-1 uses the delayed signal 104-11DEL1 to produce the respective differential signal 106 (combination of signal 106-1 and signal 106-2) conveyed over the calibration channel 128 to the communication circuit 173-2. As previously discussed, while operating in the receiver mode, the communication circuit 173-2 converts the received differential signal into the corresponding signal 104-CAL1 for the configuration setting CS3. As shown in FIG. 25, the configuration management resource 141-2 then determines a time difference between receiving the signal 104-12 and receiving the signal 104-CAL1. This can include determining a difference between a rising edge of the signal 104-12 and the rising edge of the signal 104-CAL1, resulting in the measurement of TPD-ON. Additionally or alternatively, this can include determining a time difference between a falling edge of the signal 104-12 and the falling edge of the signal 104-CAL1, resulting in the measurement of TPD-OFF. The communication management resource 141-2 stores third delay information such as TPD-ON and/or TPD-OFF for the third configuration setting (third resonant frequency setting) applied to the communication circuit 172-2. Assume that the time delay is 28 nanoseconds. This means that the delay associated with the calibration channel 128 is 28 nanoseconds minus 10 nanoseconds (from the delay circuit 225) equal to 18 nanoseconds.

The configuration management resources repeat this process of testing different possible peak resonant frequencies settings associated with the communication circuit 173-2. Because the second configuration setting CS2 in this example provides the shortest delay time (15 nanoseconds) of transmitting the delayed communication 104-11DEL1 over the calibration channel 128, the configuration management resource 141-2 applies the second configuration setting CS2 to the communication circuit 173-2. In other words, the second configuration setting associated with the shortest time delay provides best alignment of the carrier frequency 345 used to transmit from the communication circuit 173-1 and a peak frequency 350-1 (such as the selected second resonant frequency value associated with the selected configuration setting CS2) of the band-pass filter response 350 associated with the communication circuit 173-2.

It is noted that the capacitances and inductances associated with the calibration channel 128 and corresponding circuitry may change over time. Note that the combination of the configuration management resource 141-1 and the configuration management resource 141-2 can be configured to occasionally, or repeatedly over time, test the different possible configuration settings of the communication circuit 173-2 in order to tune the calibration channel, providing the shortest delay time of conveying communications over the calibration channel 128. Thus, any drift in the settings will be corrected via the repeated calibration as discussed herein. As an example, the components associated with the communication circuit 173-2 may degrade over time in which case configuration setting CS2 is no longer the optimal setting providing the shortest delay time. In such an instance, the configuration management resource 141-2 selects another configuration setting the provides the shortest delay time based on testing as previously discussed.

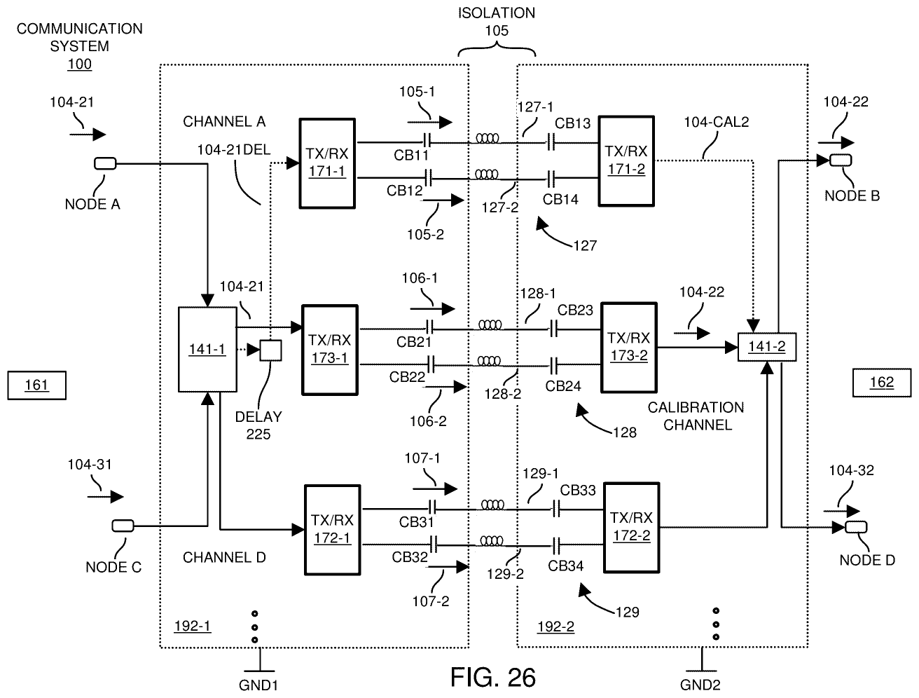

FIG. 26 is an example diagram illustrating a mode of calibrating an active channel as discussed herein.

The prior technique included calibration of the calibration channel 128 while the channel A was used to convey corresponding communications from the resource 161 to the resource 162. To calibrate the channel A, in a similar manner as previously discussed, the configuration management resource 141-1 and the configuration management resource 141-2 test application of different configuration settings to the communication circuit 171-1 and/or communication circuit 171-2 in order to align the peak frequency 350-1 of the bandpass associated with the communication circuit 171-2 to the carrier frequency of signals transmitted by the communication circuit 171-1 (see carrier frequency 345 in FIG. 19). During the calibration of the channel A, the calibration channel 128 is used to provide the uninterrupted conveyance of data from the node A to the node B.

In a similar manner as previously discussed, the configuration management resource 141-2 determines which particular configuration setting of the tested configuration settings provides the shortest time delay between the signal inputted to the communication circuit 171-1 and the corresponding signal outputted by the communication circuit 171-2. As further discussed below, that particular configuration setting associated with the shortest time delay is applied to the communication circuit 171-2 to provide the best alignment of the peak frequency 350-1 of the band-pass filter response 350 associated with the communication circuit 171-2 to the carrier frequency used to transmit signals from the communication circuit 171-1.

### Testing of Configuration Setting #1

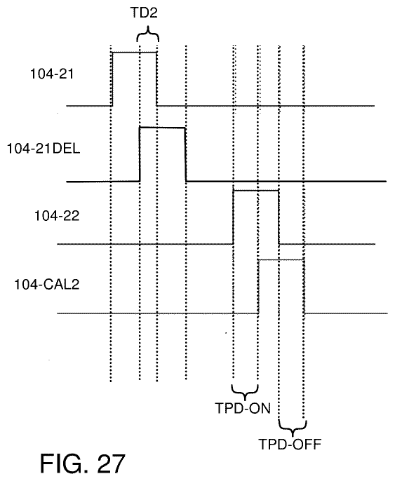

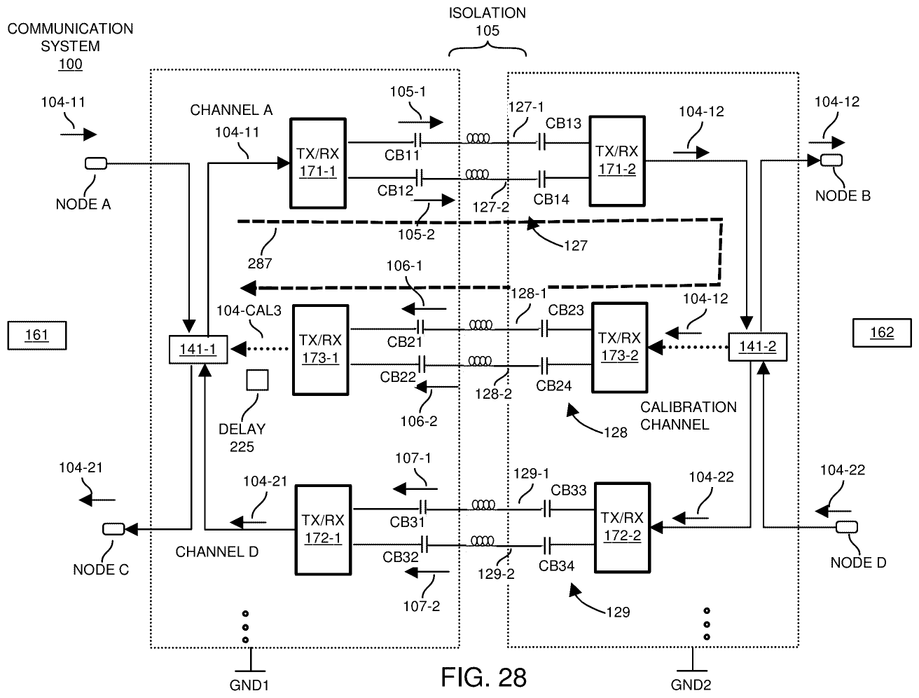

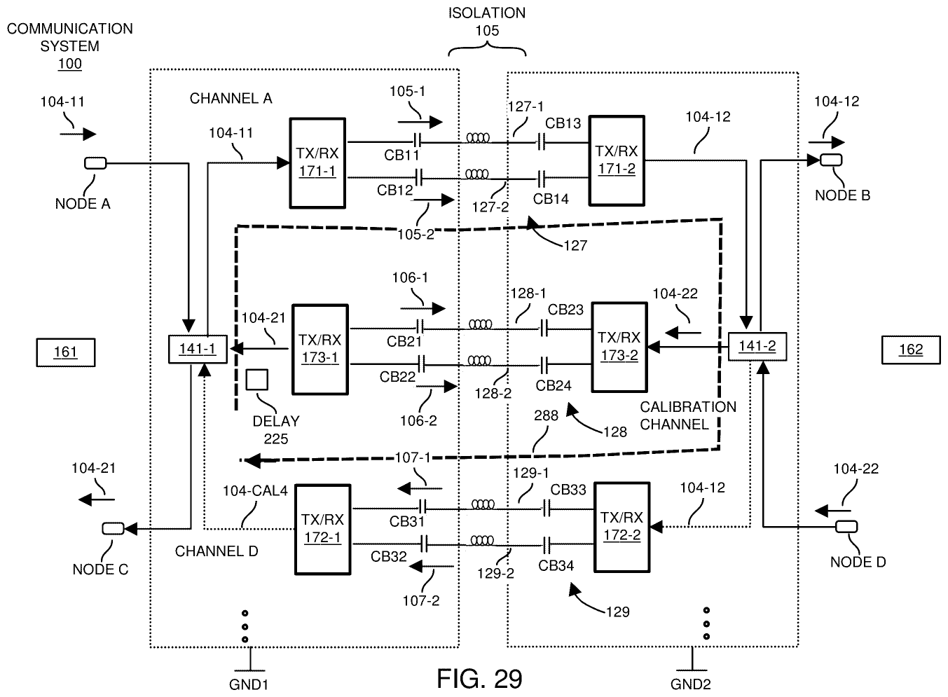

More specifically, to calibrate the channel A, the configuration management resource 141-2 first applies a first configuration setting to control a resonant frequency of the communication circuit 171-2 to a first resonant frequency value to receive the communications over the channel A. The combination of the communication management resource 141-1 and the communication management resource 141-2 then perform a test with respect to the first configuration setting and first resonant frequency value. For example, for the first configuration setting (such as a first setting of the peak frequency 350-1 applied to the communication circuit 171-2), the configuration management resource 141-1 communicates a delayed rendition of the signal 104-21 over the channel A. The delayed rendition such as signal 104-21DEL is a delayed copy of the signal 104-21. In this example, as previously discussed, the calibration channel 128 temporarily provides connectivity between the node A and node B in order to calibrate the channel A. More specifically, in furtherance of testing, the configuration management resource 141-1 implements the delay circuit 225 to delay the signal 104-21 inputted to the communication circuit 171-1. Assume that the delay circuit 225 implements a 10 nanosecond delay (TD2 or other suitable value) to delay the signal 104-21 to produce the delayed signal 104-21DEL. In such an instance, the communication circuit 171-1 receives and uses the delayed signal 104-21DEL to produce the respective differential signal 105 (combination of signal 105-1 and signal 105-2) conveyed over the channel A to the communication circuit 171-2. As previously discussed, while operating in the receiver mode, the communication circuit 171-2 converts the received differential signal into the corresponding signal 104-CAL2. As shown in FIG. 27, the configuration management resource 141-2 then determines a time difference between receiving the signal 104-22 and a time of receiving the delay signal 104-CAL2. This can include determining a difference between a rising edge of the signal 104-22 and the rising edge of the signal 104-CAL2, resulting in the measurement of TPD-ON for the first configuration setting. Additionally or alternatively, this can include determining a time difference between a falling edge of the signal 104-22 and the falling edge of the signal 104-CAL2, resulting in the measurement of TPD-OFF. Assume that the time duration associated with the TBD-ON and TPD-OFF is approximately 31 nanoseconds. The communication management resource 141-2 stores first delay information such as TPD-ON an TPD-OFF for the first configuration setting (first resonant frequency setting) applied to the communication circuit 171-2. Assume that the time delay is 10 nanoseconds. This means that the delay associated with the channel A is 31 nanoseconds minus 10 nanoseconds (from the delay circuit 225) equal to 21 nanoseconds.

### Testing of Configuration Setting #2

To further test the channel A for the best settings, the configuration management resource 141-2 applies a second configuration setting to control a resonant frequency of the communication circuit 171-2 to a second resonant frequency value to receive the communications over the channel A. The combination of the communication management resource 141-1 and the communication management resource 141-2 then perform a test with respect to the second configuration setting and second resonant frequency value. For example, for the second configuration setting (such as a second setting of the peak frequency 350-1 applied to the communication circuit 171-2), the configuration management resource 141-1 communicates a delayed rendition of the signal 104-21 over the channel A. The delayed rendition such as signal 104-21DEL is a delayed copy of the signal 104-21. In this example, as previously discussed, the calibration channel temporarily provides connectivity between the node A and node B in order to calibrate the channel A. More specifically, the configuration management resource 141-1 implements the delay circuit 225 to delay the received signal 104-21 inputted to the communication circuit 171-1. Assume that the delay circuit 225 implements a 10 nanosecond delay (TD2 or other suitable value) to delay the signal 104-21 to produce the delayed signal 104-21DEL. In such an instance, the communication circuit 171-1 uses the delayed signal 104-21DEL to produce the respective differential signal 105 (combination of signal 105-1 and signal 105-2) conveyed over the channel A to the communication circuit 171-2. As previously discussed, while operating in the receiver mode, the communication circuit 171-2 converts the received differential signal into the corresponding signal 104-CAL2. As shown in FIG. 27, the configuration management resource 141-2 then determines a time difference between receiving the signal 104-22 and receiving the signal 104-CAL2. This can include determining a difference between a rising edge of the signal 104-22 and the rising edge of the signal 104-CAL2, resulting in the measurement of TPD-ON. Additionally, or alternatively, this can include determining a time difference between a falling edge of the signal 104-22 and the falling edge of the signal 104-CAL2, resulting in the measurement of TPD-OFF. The communication management resource 141-2 stores second delay information such as TPD-ON and TPD-OFF for the second configuration setting (second resonant frequency setting) applied to the communication circuit 171-2. Assume that the time delay associated with TPD-ON and TPD-OFF is 26 nanoseconds. This means that the delay associated with the channel A is 26 nanoseconds minus 10 nanoseconds (from the delay circuit 225) equal to 16 nanoseconds.

### Testing of Configuration Setting #3

To further test the channel A, the configuration management resource 141-2 applies a third configuration setting to control a resonant frequency of the communication circuit 171-2 to a third resonant frequency value to receive the communications over the channel A. The combination of the communication management resource 141-1 and the communication management resource 141-2 then perform a test with respect to the third configuration setting and second resonant frequency value. For example, for the third configuration setting (such as a second setting of the peak frequency 350-1 applied to the communication circuit 171-2), the configuration management resource 141-1 communicates a delayed rendition of the signal 104-21 over the channel A. The delayed rendition such as signal 104-21DEL is a delayed copy of the signal 104-21. In this example, the calibration channel temporarily provides connectivity between the node A and node B in order to calibrate the channel A. More specifically, the configuration management resource 141-1 implements the delay circuit 225 to delay the signal 104-21 inputted to the communication circuit 171-1 by 10 nanoseconds for testing the channel A. Assume that the delay circuit 225 implements a 10 nanosecond delay (TD2 or other suitable value) to delay the signal 104-21 to produce the delayed signal 104-21DEL. In such an instance, the communication circuit 171-1 uses the delayed signal 104-21DEL to produce the respective differential signal 105 (combination of signal 105-1 and signal 105-2) conveyed over the channel A to the communication circuit 171-2. As previously discussed, while operating in the receiver mode, the communication circuit 171-2 converts the received differential signal into the corresponding signal 104-CAL2. As shown in FIG. 27, the configuration management resource 141-2 then determines a time difference between receiving the signal 104-22 and receiving the signal 104-CAL2. This can include determining a difference between a rising edge of the signal 104-22 and the rising edge of the signal 104-CAL2, resulting in the measurement of TPD-ON. Additionally or alternatively, this can include determining a time difference between a falling edge of the signal 104-22 and the falling edge of the signal 104-CAL2, resulting in the measurement of TPD-OFF. The communication management resource 141-2 stores third delay information such as TPD-ON and/or TPD-OFF for the third configuration setting (third resonant frequency setting) applied to the communication circuit 171-2. Assume that the measured time delay is 29 nanoseconds. This means that the delay associated with the channel A is 29 nanoseconds minus 10 nanoseconds (from the delay circuit 225) equal to 19 nanoseconds.

In a similar manner as previously discussed, the one or more configuration management resources repeat this process of testing different possible peak resonant frequencies settings associated with the communication circuit 171-2. Because the second configuration setting in this example provides the shortest delay time of transmitting the delayed communication 104-21DEL over the channel A, the configuration management resource 141-2 applies the second configuration setting to the communication circuit 171-2 to support subsequent communications. In other words, the second configuration setting associated with the shortest time delay (16 nanoseconds) corresponds to a condition of best alignment of the peak frequency 350-1 (such as the selected second resonant frequency value) of the band-pass filter response 350 associated with the communication circuit 171-2 to the carrier frequency 345 used to transmit from the communication circuit 171-1.

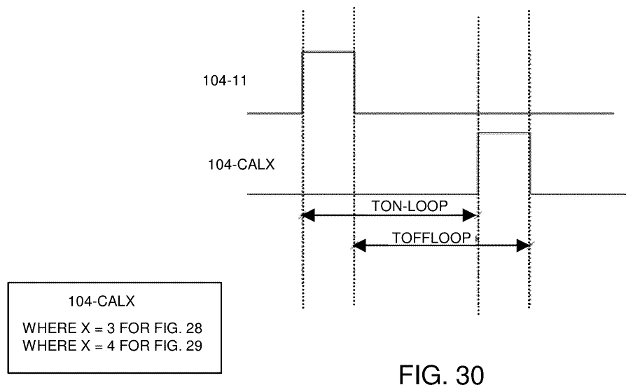

FIG. 28 is an example diagram illustrating calibration of channels in the opposite direction as discussed herein.

Another example case covered herein is when one of the channels in the communication system 100 is a downlink channel (such as channel A) and one channel such as channel D is an uplink channel (data communications in a reversed direction), as depicted in FIG. 28. The above mentioned method doesn't work in this case because the TX/RX pair that must be calibrated doesn't match the application data flow. One might try to invert the above mentioned process, by simply using the data coming from Node D pin in the same way the calibration of channel A was described. Although this works, it may lead to a conflict caused by the fact that now, the self-calibration engine on the die-2 (circuit 192-2) is deciding when to start the calibration of channel D. In other words, this system would have two masters controlling the self-calibration: The self-calibration engine on die 1 or circuit 192-1 (for CHA, CHB, and CHC) and the Self-calibration engine on die 2 (for channel D).

To avoid this conflict, one example herein includes a method to calibrate channels configured to convey data in opposite directions based on a so-called loop propagation delay concept. Here, the TPD-ON and TPD-OFF of the channel (active channel and calibration channel) are measured in a closed-loop fashion as depicted in FIG. 28. In a similar manner as previously discussed, in a first phase of calibration (FIG. 28), the idle channel (calibration channel 128) is calibrated, while keeping the channel D as the active channel in the uplink direction from the resource 162 to the resource 161. In the second phase (FIG. 29), the application data flow is transmitted via the calibration channel 128 while the channel D is calibrated by closing the loop.

Thus, in this example is shown in FIG. 28, the channel A is dedicated to convey communications such as signal 104-11 inputted to the node A. The communication circuit 171-1 receives signal 104-11 and communicates it over the channel A (via the differential signal 105) to the communication circuit 171-2 operated in the receiver mode. The communication circuit 171-2 produces the signal 104-12 outputted from node B.

To calibrate the calibration channel 128, the configuration management resource 141-2 inputs the received signal 104-12 into the communication circuit 173-2. The communication circuit 173-2 is operated in the transmitter mode transmitting the corresponding received signal 104-12 over the calibration channel 128 to the communication circuit 173-1 operated in the receiver mode. The communication circuit 173-1 converts the received differential signal 106 to the signal 104-CAL3 supplied to the configuration management resource 141-1.

Accordingly, the configuration management resource 141-1 receives the signal 104-11 as well as the closed loop (sling-back) signal 104-CAL3. As shown in FIG. 30, the configuration management resource 141-1 determines the corresponding time delay between the rising edge of the signal 104-11 and the rising edge of the signal 104-CAL3 as being the value TON-LOOP for the respective configuration setting under test. The configuration management resource 141-1 determines the corresponding time delay between the falling edge of the signal 104-11 and the falling edge of the signal 104-CAL3 as being the value TOFF-LOOP for the respective configuration setting under test.

In a similar manner as previously discussed, via application of different configuration settings to the communication circuit 173-1, the configuration management resource 141-1 tests and adjusts the corresponding peak frequency 350-1 (such as one of multiple tested resonant frequency values) of the band-pass filter response 350 associated with the communication circuit 173-1 to a resonant frequency setting value (one of the multiple tested configuration settings) that provides the shortest setting for TON-LOOP and/or TOFF-LOOP such that the peak frequency 350-1 associated with the communication circuit 173-1 aligns with the carrier frequency used by the communication circuit 173-2 to transmit the corresponding signal 104-12.

In other words, the configuration management resource 141-1 can be configured to apply a first configuration setting to the communication circuit 173-1 resulting in a delay of 45 nanoseconds such as based on one or more of TON-LOOP and/or TOFF-LOOP; the configuration management resource 141-1 can be configured to apply a second configuration setting to the communication circuit 173-1 resulting in a delay of 41 nanoseconds such as based on one or more of TON-LOOP and/or TOFF-LOOP; the configuration management resource 141-1 can be configured to apply a third configuration setting to the communication circuit 173-1 resulting in a delay of 35 nanoseconds such as based on one or more of TON-LOOP and/or TOFF-LOOP; and so on. The configuration management resource 141-2 selects the third configuration setting in which to apply to the communication circuit 173-1 because it provides the shortest loop time. This corresponds to a condition in which the channel under test such as the calibration channel provides the shortest delay time of convey communications from the communication circuit 173-2 to the communication circuit 173-1 via the feedback loop 287.

Thus, FIG. 28 illustrates how to calibrate the calibration channel 128 when operating in the uplink direction. After calibrating the calibration channel 128, the channel D is calibrated in a similar manner while the calibration channel 128 provides the uplink connectivity between the node D to the node C and the channel D is calibrated.

FIG. 29 is an example diagram illustrating calibration channels in the opposite direction as discussed herein.

Thus, in this example as shown in FIG. 29, the channel A is dedicated to convey communications such as signal 104-11 inputted to the node A. The communication circuit 171-1 receives signal 104-11 and communicates it over the channel A (via the differential signal 105) to the communication circuit 171-2 operated in the receiver mode. The communication circuit 171-2 produces the signal 104-12 outputted from node B.

To calibrate the channel D, (via sling-back provided by the loop 288) the configuration management resource 141-2 inputs the signal 104-12 into the communication circuit 172-2. The communication circuit 172-2 is operated in the transmitter mode transmitting the corresponding received signal 104-12 over the calibration channel 128 to the communication circuit 172-1 operated in the receiver mode. The communication circuit 172-1 converts the received differential signal 107 (encoding of signal 104-12) to the signal 104-CAL4 supplied to the configuration management resource 141-1.

Accordingly, the configuration management resource 141-1 receives the signal 104-11 as well as the closed loop (sling-back) signal 104-CAL4 via feedback 288. As shown in FIG. 30, the configuration management resource 141-1 determines the corresponding time delay between the rising edge of the signal 104-11 and the rising edge of the signal 104-CAL4 as being the value TON-LOOP. The configuration management resource 141-1 determines the corresponding time delay between the falling edge of the signal 104-11 and the falling edge of the signal 104-CAL4 as being the value TOFF-LOOP.

In a similar manner as previously discussed, via application of different configuration settings to the communication circuit 172-1, the configuration management resource 141-1 tests and adjusts the corresponding peak frequency 350-1 (such as one of multiple tested resonant frequency values) of the band-pass filter response 350 associated with the communication circuit 172-1 to a resonant frequency setting value (one of the multiple tested configuration settings) that provides the shortest setting for TON-LOOP and/or TOFF-LOOP such that the peak frequency 350-1 associated with the communication circuit 172-1 aligns with the carrier frequency used by the communication circuit 172-2 to transmit the corresponding signal 104-12.

In other words, the configuration management resource 141-1 can be configured to apply a first configuration setting to the communication circuit 172-1 resulting in a delay of 42 nanoseconds such as based on one or more of TON-LOOP and/or TOFF-LOOP associated with the signal 104-CAL4; the configuration management resource 141-1 can be configured to apply a second configuration setting to the communication circuit 173-1 resulting in a delay of 35 nanoseconds such as based on one or more of TON-LOOP and/or TOFF-LOOP associated with the signal 104-CAL4; the configuration management resource 141-1 can be configured to apply a third configuration setting to the communication circuit 173-1 resulting in a delay of 39 nanoseconds such as based on one or more of TON-LOOP and/or TOFF-LOOP; and so on. The configuration management resource 141-2 selects the second configuration setting in which to apply to the communication circuit 172-1 because it provides the shortest loop time. This corresponds to a condition in which the channel under test such as the channel D provides the shortest delay time of conveying communications from the communication circuit 172-2 to the communication circuit 172-1.

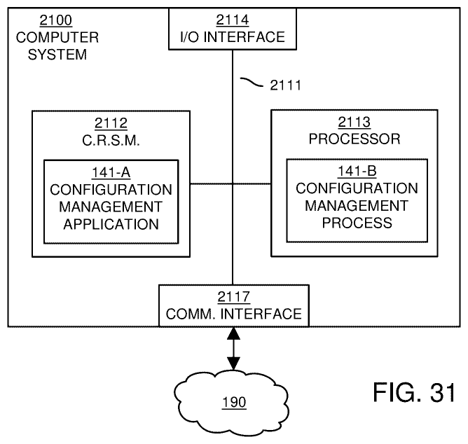

FIG. 31 is an example block diagram of a computer device or system for implementing any of the operations as discussed herein.

As shown, computer system 2100 (such as implemented by any of one or more resources such as configuration management resource 141-1, configuration management resource 141-2, etc.) of the present example includes an interconnect 2111 that couples computer readable storage media 2112 such as a non-transitory type of media (or computer hardware storage media or computer readable storage hardware) in which digital information can be stored and retrieved, a processor 2113 (e.g., computer processor hardware such as one or more processor devices), I/O interface 2114, and a communications interface 2117.

I/O interface 2114 provides connectivity to any suitable circuitry or component.

Computer readable storage medium 2112 can be any hardware storage resource or device such as memory, optical storage, hard drive, floppy disk, etc. The computer readable storage medium 2112 can be configured to store instructions and/or data used by the configuration management resource to perform any of the operations as described herein.

Further in this example, communications interface 2117 enables the computer system 2100 and processor 2113 to communicate over a resource such as network 190 to retrieve information from remote sources and communicate with other computers.

As shown, computer readable storage media 2112 is encoded with configuration management application 141-A (e.g., software, firmware, etc.) executed by processor 2113. The configuration management application 141-A can be configured to include instructions to implement any of the operations as discussed herein.

During operation, processor 2113 accesses computer readable storage media 2112 via the use of interconnect 2111 in order to launch, run, execute, interpret or otherwise perform the instructions in configuration management application 141-A stored on computer readable storage medium 2112.

Execution of the configuration management application 141-A produces processing functionality such as configuration management process 141-B in processor 2113. In other words, the configuration management process 141-B associated with processor 2113 represents one or more aspects of executing the configuration management application 141-A within or upon the processor 2113 in the computer system 2100.

Note that computer system 2100 can be a microcontroller device, logic, hardware processor, hybrid analog/digital circuitry, etc., configured to control a power supply and perform any of the operations as described herein.

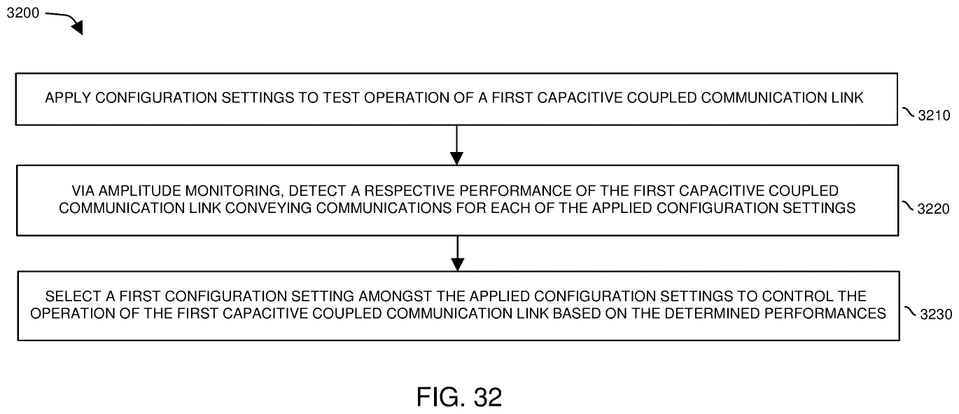

Functionality supported by the different resources will now be discussed via flowchart 3200 in FIG. 32. Note that the steps in the flowcharts below can be executed in any suitable order.

FIG. 32 is an example diagram illustrating a method of controlling a power converter.

In processing operation 3210, the configuration management resource 141 applies different configuration settings to test operation of a first capacitive coupled communication link.

In processing operation 3220, via amplitude monitoring, the configuration management resource 141 detects a respective performance of the first capacitive coupled communication link conveying communications for each of the applied configuration settings.

In processing operation 3230, the configuration management resource 141 selects a first configuration setting amongst the applied configuration settings to control the operation of the first capacitive coupled communication link based on the determined performances such as a configuration setting supporting the shortest delay time.

Note that either or both the carrier frequency (resonant frequency) of the transmitter or the peak band-pass filter settings (resonant frequency) associated with the receiver can be adjusted to achieve alignment of the peak resonant frequency of the bandpass filter to the corresponding carrier frequency of the received signal is transmitted by the corresponding transmitter.

Note again that techniques herein are well suited for use in communication system supporting conveyance of data. However, it should be noted that the concepts in this disclosure are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

It will be understood by those skilled in the art that various changes in form and details may be made therein without departing from the spirit and scope of the present application as defined by the appended claims. Such variations are intended to be covered by the scope of this present application. As such, the foregoing description of the present application is not intended to be limiting. Rather, any limitations to the invention are presented in the following claims.

We claim:

1. An apparatus comprising:
configuration management hardware operative to:
apply configuration settings to test operation of a first capacitive coupled communication link;
via amplitude monitoring, detect a respective performance of the first capacitive coupled communication link conveying communications for each of the applied configuration settings; and
select a first configuration setting amongst the applied configuration settings to control the operation of the first capacitive coupled communication link based on the determined performances.

2. The apparatus as in claim 1, wherein the amplitude monitoring includes generation of a respective peak-to-peak measurement associated with the communications conveyed over the first capacitive coupled communication link for each of the applied configuration settings.

3. The apparatus as in claim 1, wherein the amplitude monitoring includes generation of a respective envelope detection measurement associated with the communications conveyed over the first capacitive coupled communication link for each of the applied configuration settings.

4. The apparatus as in claim 1 further comprising:
a first transmitter circuit and a first receiver circuit, the first transmitter circuit operative to transmit the communications over the first capacitive coupled communication link to the first receiver circuit; and
wherein the configuration management hardware is further operative to apply the selected first configuration setting to the first capacitive coupled communication link, application of the selected first configuration setting substantially aligning a peak resonant frequency setting of the first receiver circuit with respect to a carrier frequency of the conveyed communications.

5. The apparatus as in claim 4, wherein the first transmitter circuit is operative to transmit the communications over the first capacitive coupled communication link at the carrier frequency.

6. The apparatus as in claim 1 further comprising:
a first transmitter circuit and a first receiver circuit; and
wherein the configuration management hardware is operative to determine a respective performance of the first capacitive coupled communication link for each respective configuration setting of the applied configuration settings based on a corresponding peak-to-peak measurement associated with the communications conveyed over the first capacitive coupled communication link, the communications transmitted by the first transmitter circuit over the first capacitive coupled communication link to the first receiver circuit.

7. The apparatus as in claim 6, wherein the corresponding peak-to-peak measurement for the respective configuration setting is based on a magnitude of an envelope signal associated with the communications conveyed over the first capacitive coupled communication link.

8. The apparatus as in claim 1, wherein the configuration settings include the first configuration setting and a second configuration setting;
wherein the first configuration setting is a first resonant frequency setting and the second configuration setting is a second resonant frequency setting.

9. The apparatus as in claim 1, wherein the configuration settings include the first configuration setting and a second configuration setting; and
wherein the first configuration setting is a first carrier frequency setting and the second configuration setting is a second carrier frequency setting.

10. The apparatus as in claim 1, wherein the configuration settings include the first configuration setting and a second configuration setting; and
wherein application of the first configuration setting results in a first time delay of conveying the communications over the first capacitive coupled communication link;
wherein application of the second configuration setting results in a second time delay of conveying the communications over the first capacitive coupled communication link; and
wherein the first time delay is less than the second time delay.

11. The apparatus as in claim 1, wherein the configuration management hardware is operative to the test operation of the first capacitive coupled communication link during uninterrupted transmission of data over the first capacitive coupled communication link from a transmitter circuit to a receiver circuit.

12. The apparatus as in claim 1, wherein the communications conveyed over the first capacitive coupled communication link is a modulated signal.

13. An apparatus comprising:
configuration management hardware operative to:
apply configuration settings to test operation of a first capacitive coupled communication link;
monitor performance of conveying first communications over the first capacitive coupled communication link for each of the applied configuration settings with respect to conveying second communications over a second capacitive coupled communication link; and
select a first configuration setting amongst the configuration settings to control operation of the first capacitive coupled communication link based on the monitored performance.

14. The apparatus as in claim 13, wherein the configuration management hardware is further operative to:
receive an input signal inputted to the first capacitive coupled communication link;
apply a time delay to the input signal; and
transmit the time delayed input signal over the second capacitive coupled communication link.

15. The apparatus as in claim 14, wherein the configuration management hardware is further operative to:
measure a time difference between a first time of a receiver circuit of the second capacitive coupled communication link receiving the time delayed input signal with respect to a second time of a receiver circuit of the first capacitive coupled communication link receiving the input signal.

16. A method comprising:
applying configuration settings to test operation of a first capacitive coupled communication link;
via amplitude monitoring, determining a respective performance of the first capacitive coupled communication link to convey communications for each of the applied configuration settings; and
based on the determined performances, selecting a first configuration setting amongst the applied configuration settings to control operation of the first capacitive coupled communication link.

17. The method as in claim 16, wherein the amplitude monitoring includes generation of a respective peak-to-peak measurement associated with the communications conveyed over the first capacitive coupled communication link for each of the applied configuration settings.

18. The method as in claim 16, wherein the amplitude monitoring includes generation of a respective envelope detection measurement associated with the communications conveyed over the first capacitive coupled communication link for each of the applied configuration settings.

19. The method as in claim 18 further comprising:
via a first transmitter circuit, transmitting the communications over the first capacitive coupled communication link to a first receiver circuit; and
applying the selected first configuration setting to the first receiver circuit, application of the selected first configuration setting substantially aligning a peak resonant frequency setting of the first receiver circuit with respect to a carrier frequency of the conveyed communications.

20. The method as in claim 19 further comprising:
transmitting the communications from the first transmitter circuit over the first capacitive coupled communication link at the carrier frequency.
